(19) United States
(12) Patent Application Publication
(10) Pub. No.: US 2026/0140134 A1
(43) Pub. Date: May 21, 2026

(54) TECHNIQUES FOR DETECTING MOTION

(71) Applicant: Apple Inc., Cupertino, CA (US)

(72) Inventors: Kartik NARANG, Fremont, CA (US); Zaka U. ASHRAF, Pleasanton, CA (US); Akshath R. JAIN, Sunnyvale, CA (US); Keith W. RAUENBUEHLER, San Francisco, CA (US); Michael A. BEBENITA, San Francisco, CA (US)

(21) Appl. No.: 19/394,625

(22) Filed: Nov. 19, 2025

Related U.S. Application Data
(60) Provisional application No. 63/722,200, filed on Nov. 19, 2024.

(51) Int. Cl. G01P 13/00; G06T 7/215; G08B 13/196

(52) U.S. Cl. CPC G01P 13/00; G06T 7/215; G06T 2207/10016; G08B 13/1961

(57) ABSTRACT

The present disclosure generally relates to detecting motion using a combination of video-based and audio-based motion detection models in accordance with some embodiments.

### CROSS-REFERENCE TO RELATED APPLICATIONS

This application claims priority to U.S. Provisional Patent Application Ser. No. 63/722,200, entitled “TECHNIQUES FOR DETECTING MOTION,” filed Nov. 19, 2024. The content of these application(s) is hereby incorporated by reference in their entirety.

### BACKGROUND

Electronic devices with audio and/or video capabilities are becoming increasingly prevalent in home security systems. For example, cameras and/or microphones are often integrated into doorbells, security systems, and smart home accessories to monitor activity. While traditional motion detection primarily relies on visual processing, such techniques can be computationally intensive and may fail in certain environmental conditions and/or when motion occurs outside of a visual detection range. Accordingly, there is a need for more efficient and reliable motion detection techniques that can work across different computational environments and leverage both audio and visual data for improved accuracy.

### SUMMARY

Current techniques for detecting motion are generally ineffective and/or inefficient. For example, some techniques require higher computational resources to extensively process visual data or fail to detect motion when relying only on visual-based detection methods. This disclosure provides more effective and/or efficient techniques for detecting motion using a dynamically adaptable combination of audio and visual detection. It should be recognized that other types of data can be used with techniques described herein. For example, cameras, microphones, home automation activity logs, and/or ultrasonic sensors can be combined to detect motion. In addition, techniques optionally complement or replace other techniques for detecting motion.

Some techniques described herein include detecting motion using a higher-compute technique that combines optical flow analysis of visual frames with audio-based motion detection. For example, combining processing video frames using a deep optical flow algorithm with analyzing audio signal through an audio-based motion detection model to detect motion. Other techniques described herein include detecting motion using a lower-compute technique that combines frame differencing of visual frames with audio-based motion detection. For example, combining calculating differences between consecutive video frames in foreground regions of the consecutive video frames with processing audio patterns through an audio-based motion detection model to detect motion. Other techniques described herein include detecting motion before it becomes visually apparent by analyzing audio data to identify potential motion events before the motion events are visually detectable. For example, detecting motion via analyzing footstep sounds through an audio-based motion detection model before a source of footsteps appears in video frames.

In some embodiments, a method that is performed at a computer system is described. In some embodiments, the method comprises: receiving one or more visual frames; receiving one or more audio frames corresponding to the one or more visual frames; after receiving the one or more visual frames and the one or more audio frames: identifying, based on an optical flow in the one or more visual frames, a first motion indication; and identifying, based on the one or more audio frames without being based on the one or more visual frames, a second motion indication separate from the first motion indication; and after identifying the first motion indication and the second motion indication: in accordance with a determination that a first set of one or more criteria is satisfied, wherein the first set of one or more criteria includes a criterion that is satisfied based on the first motion indication and the second motion indication, outputting a first indication that motion has been detected; and in accordance with a determination that a second set of one or more criteria is satisfied, wherein the second set of one or more criteria includes a criterion that is satisfied based on the first motion indication and the second motion indication, forgoing output of an indication that motion has been detected, wherein the second set of one or more criteria is different from the first set of one or more criteria.

In some embodiments, a non-transitory computer-readable storage medium storing one or more programs configured to be executed by one or more processors of a computer system is described. In some embodiments, the one or more programs includes instructions for: receiving one or more visual frames; receiving one or more audio frames corresponding to the one or more visual frames; after receiving the one or more visual frames and the one or more audio frames: identifying, based on an optical flow in the one or more visual frames, a first motion indication; and identifying, based on the one or more audio frames without being based on the one or more visual frames, a second motion indication separate from the first motion indication; and after identifying the first motion indication and the second motion indication: in accordance with a determination that a first set of one or more criteria is satisfied, wherein the first set of one or more criteria includes a criterion that is satisfied based on the first motion indication and the second motion indication, outputting a first indication that motion has been detected; and in accordance with a determination that a second set of one or more criteria is satisfied, wherein the second set of one or more criteria includes a criterion that is satisfied based on the first motion indication and the second motion indication, forgoing output of an indication that motion has been detected, wherein the second set of one or more criteria is different from the first set of one or more criteria.

In some embodiments, a transitory computer-readable storage medium storing one or more programs configured to be executed by one or more processors of a computer system is described. In some embodiments, the one or more programs includes instructions for: receiving one or more visual frames; receiving one or more audio frames corresponding to the one or more visual frames; after receiving the one or more visual frames and the one or more audio frames: identifying, based on an optical flow in the one or more visual frames, a first motion indication; and identifying, based on the one or more audio frames without being based on the one or more visual frames, a second motion indication separate from the first motion indication; and after identifying the first motion indication and the second motion indication: in accordance with a determination that a first set of one or more criteria is satisfied, wherein the first set of one or more criteria includes a criterion that is satisfied based on the first motion indication and the second motion indication, outputting a first indication that motion has been detected; and in accordance with a determination that a second set of one or more criteria is satisfied, wherein the second set of one or more criteria includes a criterion that is satisfied based on the first motion indication and the second motion indication, forgoing output of an indication that motion has been detected, wherein the second set of one or more criteria is different from the first set of one or more criteria.

In some embodiments, a computer system is described. In some embodiments, the computer system comprises one or more processors and memory storing one or more programs configured to be executed by the one or more processors. In some embodiments, the one or more programs includes instructions for: receiving one or more visual frames; receiving one or more audio frames corresponding to the one or more visual frames; after receiving the one or more visual frames and the one or more audio frames: identifying, based on an optical flow in the one or more visual frames, a first motion indication; and identifying, based on the one or more audio frames without being based on the one or more visual frames, a second motion indication separate from the first motion indication; and after identifying the first motion indication and the second motion indication: in accordance with a determination that a first set of one or more criteria is satisfied, wherein the first set of one or more criteria includes a criterion that is satisfied based on the first motion indication and the second motion indication, outputting a first indication that motion has been detected; and in accordance with a determination that a second set of one or more criteria is satisfied, wherein the second set of one or more criteria includes a criterion that is satisfied based on the first motion indication and the second motion indication, forgoing output of an indication that motion has been detected, wherein the second set of one or more criteria is different from the first set of one or more criteria.

In some embodiments, a computer system is described. In some embodiments, the computer system comprises means for performing each of the following steps: receiving one or more visual frames; receiving one or more audio frames corresponding to the one or more visual frames; after receiving the one or more visual frames and the one or more audio frames: identifying, based on an optical flow in the one or more visual frames, a first motion indication; and identifying, based on the one or more audio frames without being based on the one or more visual frames, a second motion indication separate from the first motion indication; and after identifying the first motion indication and the second motion indication: in accordance with a determination that a first set of one or more criteria is satisfied, wherein the first set of one or more criteria includes a criterion that is satisfied based on the first motion indication and the second motion indication, outputting a first indication that motion has been detected; and in accordance with a determination that a second set of one or more criteria is satisfied, wherein the second set of one or more criteria includes a criterion that is satisfied based on the first motion indication and the second motion indication, forgoing output of an indication that motion has been detected, wherein the second set of one or more criteria is different from the first set of one or more criteria.

In some embodiments, a computer program product is described. In some embodiments, the computer program product comprises one or more programs configured to be executed by one or more processors of a computer system. In some embodiments, the one or more programs include instructions for: receiving one or more visual frames; receiving one or more audio frames corresponding to the one or more visual frames; after receiving the one or more visual frames and the one or more audio frames: identifying, based on an optical flow in the one or more visual frames, a first motion indication; and identifying, based on the one or more audio frames without being based on the one or more visual frames, a second motion indication separate from the first motion indication; and after identifying the first motion indication and the second motion indication: in accordance with a determination that a first set of one or more criteria is satisfied, wherein the first set of one or more criteria includes a criterion that is satisfied based on the first motion indication and the second motion indication, outputting a first indication that motion has been detected; and in accordance with a determination that a second set of one or more criteria is satisfied, wherein the second set of one or more criteria includes a criterion that is satisfied based on the first motion indication and the second motion indication, forgoing output of an indication that motion has been detected, wherein the second set of one or more criteria is different from the first set of one or more criteria.

In some embodiments, a method that is performed at a computer system is described. In some embodiments, the method comprises: receiving multiple visual frames; receiving one or more audio frames corresponding to the multiple visual frames; after receiving the multiple visual frames and the one or more audio frames: identifying, based on frame differencing of the multiple visual frames, a first motion indication; and identifying, based on the one or more audio frames without being based on the multiple visual frames, a second motion indication separate from the first motion indication; and after identifying the first motion indication and the second motion indication: in accordance with a determination that a first set of one or more criteria is satisfied, wherein the first set of one or more criteria includes a criterion that is satisfied based on the first motion indication and the second motion indication, outputting a first indication that motion has been detected; and in accordance with a determination that a second set of one or more criteria is satisfied, wherein the second set of one or more criteria includes a criterion that is satisfied based on the first motion indication and the second motion indication, forgoing output of an indication that motion has been detected, wherein the second set of one or more criteria is different from the first set of one or more criteria.

In some embodiments, a non-transitory computer-readable storage medium storing one or more programs configured to be executed by one or more processors of a computer system is described. In some embodiments, the one or more programs includes instructions for: receiving multiple visual frames; receiving one or more audio frames corresponding to the multiple visual frames; after receiving the multiple visual frames and the one or more audio frames: identifying, based on frame differencing of the multiple visual frames, a first motion indication; and identifying, based on the one or more audio frames without being based on the multiple visual frames, a second motion indication separate from the first motion indication; and after identifying the first motion indication and the second motion indication: in accordance with a determination that a first set of one or more criteria is satisfied, wherein the first set of one or more criteria includes a criterion that is satisfied based on the first motion indication and the second motion indication, outputting a first indication that motion has been detected; and in accordance with a determination that a second set of one or more criteria is satisfied, wherein the second set of one or more criteria includes a criterion that is satisfied based on the first motion indication and the second motion indication, forgoing output of an indication that motion has been detected, wherein the second set of one or more criteria is different from the first set of one or more criteria.

In some embodiments, a transitory computer-readable storage medium storing one or more programs configured to be executed by one or more processors of a computer system is described. In some embodiments, the one or more programs includes instructions for: receiving multiple visual frames; receiving one or more audio frames corresponding to the multiple visual frames; after receiving the multiple visual frames and the one or more audio frames: identifying, based on frame differencing of the multiple visual frames, a first motion indication; and identifying, based on the one or more audio frames without being based on the multiple visual frames, a second motion indication separate from the first motion indication; and after identifying the first motion indication and the second motion indication: in accordance with a determination that a first set of one or more criteria is satisfied, wherein the first set of one or more criteria includes a criterion that is satisfied based on the first motion indication and the second motion indication, outputting a first indication that motion has been detected; and in accordance with a determination that a second set of one or more criteria is satisfied, wherein the second set of one or more criteria includes a criterion that is satisfied based on the first motion indication and the second motion indication, forgoing output of an indication that motion has been detected, wherein the second set of one or more criteria is different from the first set of one or more criteria.

In some embodiments, a computer system is described. In some embodiments, the computer system comprises one or more processors and memory storing one or more programs configured to be executed by the one or more processors. In some embodiments, the one or more programs includes instructions for: receiving multiple visual frames; receiving one or more audio frames corresponding to the multiple visual frames; after receiving the multiple visual frames and the one or more audio frames: identifying, based on frame differencing of the multiple visual frames, a first motion indication; and identifying, based on the one or more audio frames without being based on the multiple visual frames, a second motion indication separate from the first motion indication; and after identifying the first motion indication and the second motion indication: in accordance with a determination that a first set of one or more criteria is satisfied, wherein the first set of one or more criteria includes a criterion that is satisfied based on the first motion indication and the second motion indication, outputting a first indication that motion has been detected; and in accordance with a determination that a second set of one or more criteria is satisfied, wherein the second set of one or more criteria includes a criterion that is satisfied based on the first motion indication and the second motion indication, forgoing output of an indication that motion has been detected, wherein the second set of one or more criteria is different from the first set of one or more criteria.

In some embodiments, a computer system is described. In some embodiments, the computer system comprises means for performing each of the following steps: receiving multiple visual frames; receiving one or more audio frames corresponding to the multiple visual frames; after receiving the multiple visual frames and the one or more audio frames: identifying, based on frame differencing of the multiple visual frames, a first motion indication; and identifying, based on the one or more audio frames without being based on the multiple visual frames, a second motion indication separate from the first motion indication; and after identifying the first motion indication and the second motion indication: in accordance with a determination that a first set of one or more criteria is satisfied, wherein the first set of one or more criteria includes a criterion that is satisfied based on the first motion indication and the second motion indication, outputting a first indication that motion has been detected; and in accordance with a determination that a second set of one or more criteria is satisfied, wherein the second set of one or more criteria includes a criterion that is satisfied based on the first motion indication and the second motion indication, forgoing output of an indication that motion has been detected, wherein the second set of one or more criteria is different from the first set of one or more criteria.

In some embodiments, a computer program product is described. In some embodiments, the computer program product comprises one or more programs configured to be executed by one or more processors of a computer system. In some embodiments, the one or more programs include instructions for: receiving multiple visual frames; receiving one or more audio frames corresponding to the multiple visual frames; after receiving the multiple visual frames and the one or more audio frames: identifying, based on frame differencing of the multiple visual frames, a first motion indication; and identifying, based on the one or more audio frames without being based on the multiple visual frames, a second motion indication separate from the first motion indication; and after identifying the first motion indication and the second motion indication: in accordance with a determination that a first set of one or more criteria is satisfied, wherein the first set of one or more criteria includes a criterion that is satisfied based on the first motion indication and the second motion indication, outputting a first indication that motion has been detected; and in accordance with a determination that a second set of one or more criteria is satisfied, wherein the second set of one or more criteria includes a criterion that is satisfied based on the first motion indication and the second motion indication, forgoing output of an indication that motion has been detected, wherein the second set of one or more criteria is different from the first set of one or more criteria.

In some embodiments, a method that is performed at a computer system that is in communication with one or more cameras and one or more microphones is described. In some embodiments, the method comprises: capturing, via the one or more cameras, video of an environment; capturing, via the one or more microphones, audio of the environment; while capturing the video of the environment and the audio of the environment, detecting, based on the audio of the environment and not based on the video of the environment, that the environment includes motion that satisfies a set of one or more criteria; in response to detecting, based on the audio of the environment and not based on the video of the environment, that the environment includes motion that satisfies the set of one or more criteria, outputting a first indication that motion has been detected in the environment; after outputting the first indication that motion has been detected in the environment, detecting, based on the video of the environment, that the environment includes motion that satisfies the set of one or more criteria; and in response to detecting, based on the video of the environment, that the environment includes motion that satisfies the set of one or more criteria, outputting a second indication that motion has been detected in the environment, wherein the second indication is separate from the first indication.

In some embodiments, a non-transitory computer-readable storage medium storing one or more programs configured to be executed by one or more processors of a computer system that is in communication with one or more cameras and one or more microphones is described. In some embodiments, the one or more programs includes instructions for: capturing, via the one or more cameras, video of an environment; capturing, via the one or more microphones, audio of the environment; while capturing the video of the environment and the audio of the environment, detecting, based on the audio of the environment and not based on the video of the environment, that the environment includes motion that satisfies a set of one or more criteria; in response to detecting, based on the audio of the environment and not based on the video of the environment, that the environment includes motion that satisfies the set of one or more criteria, outputting a first indication that motion has been detected in the environment; after outputting the first indication that motion has been detected in the environment, detecting, based on the video of the environment, that the environment includes motion that satisfies the set of one or more criteria; and in response to detecting, based on the video of the environment, that the environment includes motion that satisfies the set of one or more criteria, outputting a second indication that motion has been detected in the environment, wherein the second indication is separate from the first indication.

In some embodiments, a transitory computer-readable storage medium storing one or more programs configured to be executed by one or more processors of a computer system that is in communication with one or more cameras and one or more microphones is described. In some embodiments, the one or more programs includes instructions for: capturing, via the one or more cameras, video of an environment; capturing, via the one or more microphones, audio of the environment; while capturing the video of the environment and the audio of the environment, detecting, based on the audio of the environment and not based on the video of the environment, that the environment includes motion that satisfies a set of one or more criteria; in response to detecting, based on the audio of the environment and not based on the video of the environment, that the environment includes motion that satisfies the set of one or more criteria, outputting a first indication that motion has been detected in the environment; after outputting the first indication that motion has been detected in the environment, detecting, based on the video of the environment, that the environment includes motion that satisfies the set of one or more criteria; and in response to detecting, based on the video of the environment, that the environment includes motion that satisfies the set of one or more criteria, outputting a second indication that motion has been detected in the environment, wherein the second indication is separate from the first indication.

In some embodiments, a computer system configured to communicate with one or more cameras and one or more microphones is described. In some embodiments, the computer system comprises one or more processors and memory storing one or more programs configured to be executed by the one or more processors. In some embodiments, the one or more programs includes instructions for: capturing, via the one or more cameras, video of an environment; capturing, via the one or more microphones, audio of the environment; while capturing the video of the environment and the audio of the environment, detecting, based on the audio of the environment and not based on the video of the environment, that the environment includes motion that satisfies a set of one or more criteria; in response to detecting, based on the audio of the environment and not based on the video of the environment, that the environment includes motion that satisfies the set of one or more criteria, outputting a first indication that motion has been detected in the environment; after outputting the first indication that motion has been detected in the environment, detecting, based on the video of the environment, that the environment includes motion that satisfies the set of one or more criteria; and in response to detecting, based on the video of the environment, that the environment includes motion that satisfies the set of one or more criteria, outputting a second indication that motion has been detected in the environment, wherein the second indication is separate from the first indication.

In some embodiments, a computer system configured to communicate with one or more cameras and one or more microphones is described. In some embodiments, the computer system comprises means for performing each of the following steps: capturing, via the one or more cameras, video of an environment; capturing, via the one or more microphones, audio of the environment; while capturing the video of the environment and the audio of the environment, detecting, based on the audio of the environment and not based on the video of the environment, that the environment includes motion that satisfies a set of one or more criteria; in response to detecting, based on the audio of the environment and not based on the video of the environment, that the environment includes motion that satisfies the set of one or more criteria, outputting a first indication that motion has been detected in the environment; after outputting the first indication that motion has been detected in the environment, detecting, based on the video of the environment, that the environment includes motion that satisfies the set of one or more criteria; and in response to detecting, based on the video of the environment, that the environment includes motion that satisfies the set of one or more criteria, outputting a second indication that motion has been detected in the environment, wherein the second indication is separate from the first indication.

In some embodiments, a computer program product is described. In some embodiments, the computer program product comprises one or more programs configured to be executed by one or more processors of a computer system that is in communication with one or more cameras and one or more microphones. In some embodiments, the one or more programs include instructions for: capturing, via the one or more cameras, video of an environment; capturing, via the one or more microphones, audio of the environment; while capturing the video of the environment and the audio of the environment, detecting, based on the audio of the environment and not based on the video of the environment, that the environment includes motion that satisfies a set of one or more criteria; in response to detecting, based on the audio of the environment and not based on the video of the environment, that the environment includes motion that satisfies the set of one or more criteria, outputting a first indication that motion has been detected in the environment; after outputting the first indication that motion has been detected in the environment, detecting, based on the video of the environment, that the environment includes motion that satisfies the set of one or more criteria; and in response to detecting, based on the video of the environment, that the environment includes motion that satisfies the set of one or more criteria, outputting a second indication that motion has been detected in the environment, wherein the second indication is separate from the first indication.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1A is a block diagram illustrating a compute system in accordance with some embodiments.

FIGS. 1B-1G illustrate the use of Application Programming Interfaces (APIs) to perform operations in accordance with some embodiments.

FIG. 2 is a block diagram illustrating a device with interconnected subsystems in accordance with some embodiments.

FIG. 3 illustrates an exemplary process for training an audio-based motion detection model in accordance with some embodiments.

FIG. 4 illustrates an exemplary process for detecting motion in a video frame using a vision-based motion detection technique in accordance with some embodiments.

FIG. 5 illustrates an exemplary process for performing resource-adaptive motion detection in accordance with some embodiments.

FIG. 6 illustrates an exemplary process for comparing motion detection techniques in accordance with some embodiments.

FIG. 7 is a flow diagram illustrating a process for detecting motion using optical flow and an audio model in accordance with some embodiments.

FIG. 8 is a flow diagram illustrating a process for detecting motion using frame differencing and an audio model in accordance with some embodiments.

FIG. 9 is a flow diagram illustrating a process for detecting motion using audio before detecting visual motion in accordance with some embodiments.

### DETAILED DESCRIPTION

The following description sets forth exemplary processes, parameters, and the like. It should be recognized, however, that such description is not intended as a limitation on the scope of the present disclosure but is instead provided as a description of exemplary embodiments.

Processes described herein can include one or more steps that are contingent upon one or more conditions being satisfied. It should be understood that a process can occur over multiple iterations of the same process with different steps of the process being satisfied in different iterations. For example, if a process requires performing a first step upon a determination that a set of one or more criteria is met and a second step upon a determination that the set of one or more criteria is not met, a person of ordinary skill in the art would appreciate that the steps of the process are repeated until both conditions, in no particular order, are satisfied. Thus, a process described with steps that are contingent upon a condition being satisfied can be rewritten as a process that is repeated until each of the conditions described in the process are satisfied. This, however, is not required of system or computer readable medium claims where the system or computer readable medium claims include instructions for performing one or more steps that are contingent upon one or more conditions being satisfied. Because the instructions for the system or computer readable medium claims are stored in one or more processors and/or at one or more memory locations, the system or computer readable medium claims include logic that can determine whether the one or more conditions have been satisfied without explicitly repeating steps of a process until all of the conditions upon which steps in the process are contingent have been satisfied. A person having ordinary skill in the art would also understand that, similar to a process with contingent steps, a system or computer readable storage medium can repeat the steps of a process as many times as needed to ensure that all of the contingent steps have been performed.

Although the following description uses terms “first,” “second,” etc. to describe various elements, these elements should not be limited by the terms unless explicitly stated with an order and/or that they are separate and/or different. In some embodiments, these terms are used to distinguish one element from another. For example, a first subsystem could be termed a second subsystem, and, similarly, a second subsystem device or a subsystem device could be termed a first subsystem device, without departing from the scope of the various described embodiments. In some embodiments, the first subsystem and the second subsystem are two separate references to the same subsystem. In some embodiments, the first subsystem and the second subsystem are both subsystems, but they are not the same subsystem or the same type of subsystem.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when,” “upon,” “in response to determining,” “in response to detecting,” or “in accordance with a determination that” depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” or “in accordance with a determination that [the stated condition or event]” depending on the context.

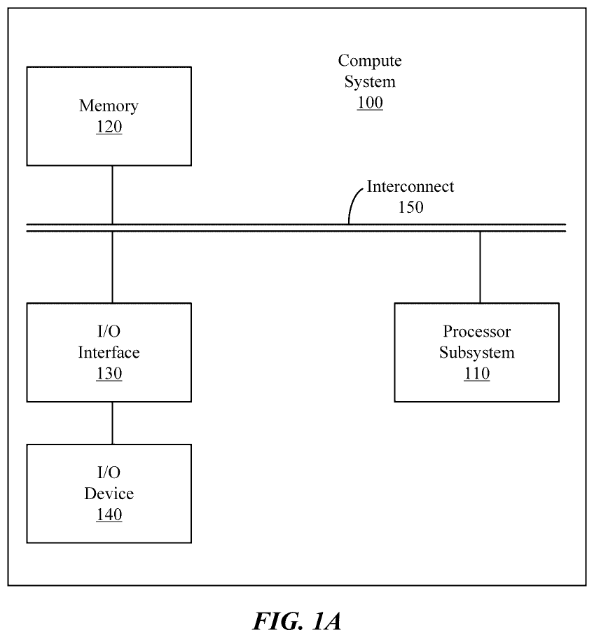

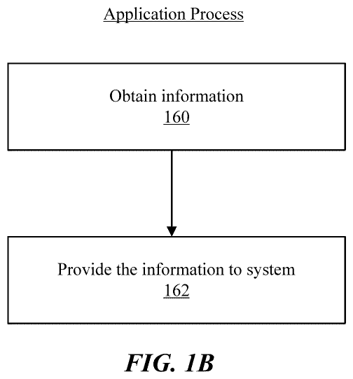

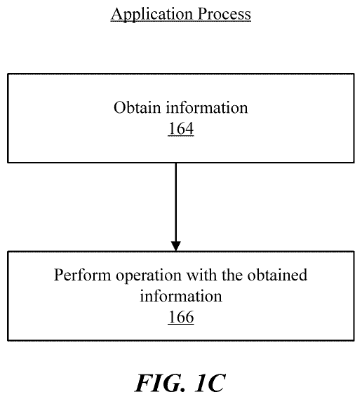

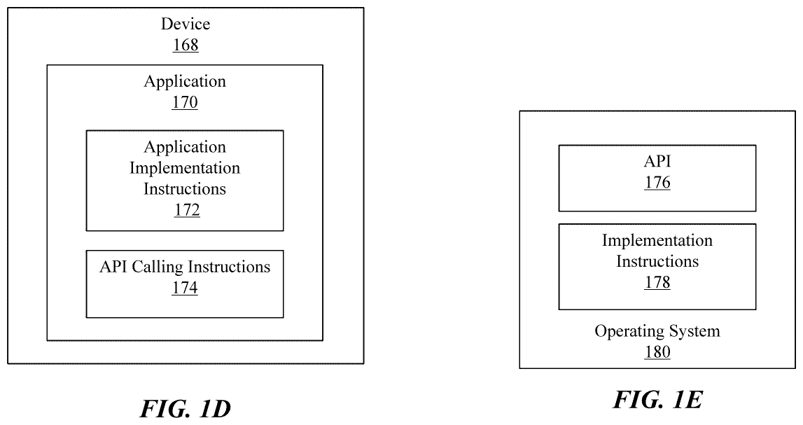

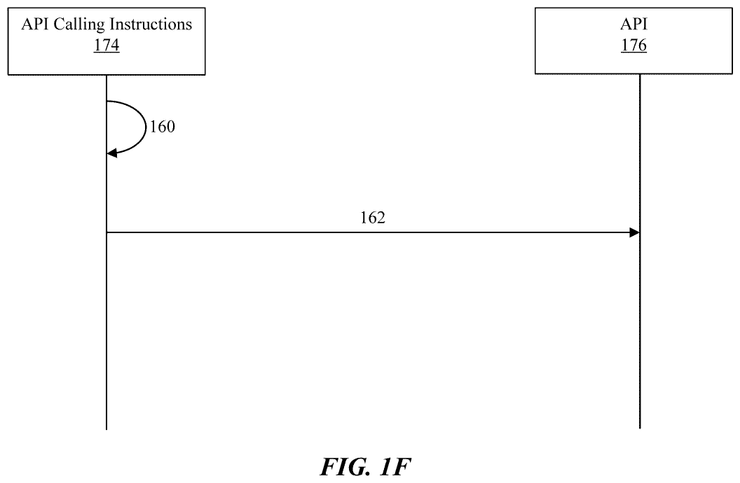

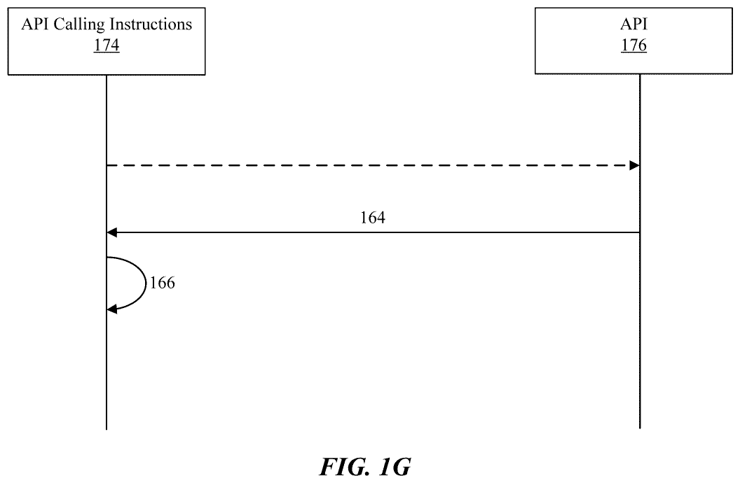

Turning to FIG. 1A, a block diagram of compute system 100 is illustrated. Compute system 100 is a non-limiting example of a compute system that can be used to perform functionality described herein. It should be recognized that other computer architectures of a compute system can be used to perform functionality described herein.

In the illustrated example, compute system 100 includes processor subsystem 110 communicating with (e.g., wired or wirelessly) memory 120 (e.g., a system memory) and I/O interface 130 via interconnect 150 (e.g., a system bus, one or more memory locations, or other communication channel for connecting multiple components of compute system 100). In addition, I/O interface 130 is communicating with (e.g., wired or wirelessly) to I/O device 140. In some embodiments, I/O interface 130 is included with I/O device 140 such that the two are a single component. It should be recognized that there can be one or more I/O interfaces, with each I/O interface communicating with one or more I/O devices. In some embodiments, multiple instances of processor subsystem 110 can be communicating via interconnect 150.

Compute system 100 can be any of various types of devices, including, but not limited to, a system on a chip, a server system, a personal computer system (e.g., a smartphone, a smartwatch, a wearable device, a tablet, a laptop computer, and/or a desktop computer), a sensor, or the like. In some embodiments, compute system 100 is included or communicating with a physical component for the purpose of modifying the physical component in response to an instruction. In some embodiments, compute system 100 receives an instruction to modify a physical component and, in response to the instruction, causes the physical component to be modified. In some embodiments, the physical component is modified via an actuator, an electric signal, and/or algorithm. Examples of such physical components include an acceleration control, a break, a gear box, a hinge, a motor, a pump, a refrigeration system, a spring, a suspension system, a steering control, a pump, a vacuum system, and/or a valve. In some embodiments, a sensor includes one or more hardware components that detect information about a physical environment in proximity to (e.g., surrounding) the sensor. In some embodiments, a hardware component of a sensor includes a sensing component (e.g., an image sensor or temperature sensor), a transmitting component (e.g., a laser or radio transmitter), a receiving component (e.g., a laser or radio receiver), or any combination thereof. Examples of sensors include an angle sensor, a chemical sensor, a brake pressure sensor, a contact sensor, a non-contact sensor, an electrical sensor, a flow sensor, a force sensor, a gas sensor, a humidity sensor, an image sensor (e.g., a camera sensor, a radar sensor, and/or a LiDAR sensor), an inertial measurement unit, a leak sensor, a level sensor, a light detection and ranging system, a metal sensor, a motion sensor, a particle sensor, a photoelectric sensor, a position sensor (e.g., a global positioning system), a precipitation sensor, a pressure sensor, a proximity sensor, a radio detection and ranging system, a radiation sensor, a speed sensor (e.g., measures the speed of an object), a temperature sensor, a time-of-flight sensor, a torque sensor, and an ultrasonic sensor. In some embodiments, a sensor includes a combination of multiple sensors. In some embodiments, sensor data is captured by fusing data from one sensor with data from one or more other sensors. Although a single compute system is shown in FIG. 1A, compute system 100 can also be implemented as two or more compute systems operating together.

In some embodiments, processor subsystem 110 includes one or more processors or processing units configured to execute program instructions to perform functionality described herein. For example, processor subsystem 110 can execute an operating system, a middleware system, one or more applications, or any combination thereof.

In some embodiments, the operating system manages resources of compute system 100. Examples of types of operating systems covered herein include batch operating systems (e.g., Multiple Virtual Storage (MVS)), time-sharing operating systems (e.g., Unix), distributed operating systems (e.g., Advanced Interactive eXecutive (AIX), network operating systems (e.g., Microsoft Windows Server), and real-time operating systems (e.g., QNX). In some embodiments, the operating system includes various procedures, sets of instructions, software components, and/or drivers for controlling and managing general system tasks (e.g., memory management, storage device control, power management, or the like) and for facilitating communication between various hardware and software components. In some embodiments, the operating system uses a priority-based scheduler that assigns a priority to different tasks that processor subsystem 110 can execute. In such examples, the priority assigned to a task is used to identify a next task to execute. In some embodiments, the priority-based scheduler identifies a next task to execute when a previous task finishes executing. In some embodiments, the highest priority task runs to completion unless another higher priority task is made ready.

In some embodiments, the middleware system provides one or more services and/or capabilities to applications (e.g., the one or more applications running on processor subsystem 110) outside of what the operating system offers (e.g., data management, application services, messaging, authentication, API management, or the like). In some embodiments, the middleware system is designed for a heterogeneous computer cluster to provide hardware abstraction, low-level device control, implementation of commonly used functionality, message-passing between processes, package management, or any combination thereof. Examples of middleware systems include Lightweight Communications and Marshalling (LCM), PX4, Robot Operating System (ROS), and ZeroMQ. In some embodiments, the middleware system represents processes and/or operations using a graph architecture, where processing takes place in nodes that can receive, post, and multiplex sensor data messages, control messages, state messages, planning messages, actuator messages, and other messages. In such examples, the graph architecture can define an application (e.g., an application executing on processor subsystem 110 as described above) such that different operations of the application are included with different nodes in the graph architecture.

In some embodiments, a message sent from a first node in a graph architecture to a second node in the graph architecture is performed using a publish-subscribe model, where the first node publishes data on a channel in which the second node can subscribe. In such examples, the first node can store data in memory (e.g., memory 120 or some local memory of processor subsystem 110) and notify the second node that the data has been stored in the memory. In some embodiments, the first node notifies the second node that the data has been stored in the memory by sending a pointer (e.g., a memory pointer, such as an identification of a memory location) to the second node so that the second node can access the data from where the first node stored the data. In some embodiments, the first node would send the data directly to the second node so that the second node would not need to access a memory based on data received from the first node.

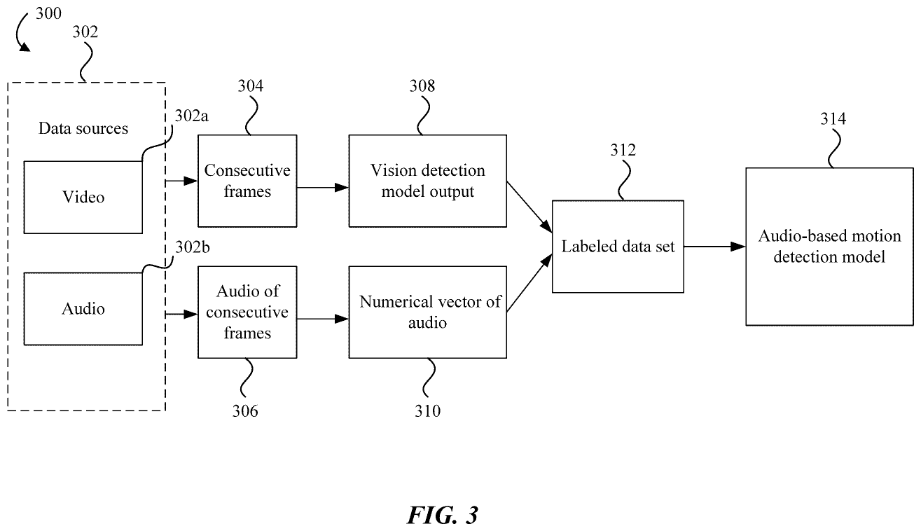

Memory 120 can include a computer readable medium (e.g., non-transitory or transitory computer readable medium) usable to store (e.g., configured to store, assigned to store, and/or that stores) program instructions executable by processor subsystem 110 to cause compute system 100 to perform various operations described herein. For example, memory 120 can store program instructions to implement the functionality associated with processes 300, 400, 500, 700, 800, and 900 (FIGS. 3, 4, 5, 7, 8, and 9) described below.

Memory 120 can be implemented using different physical, non-transitory memory media, such as hard disk storage, floppy disk storage, removable disk storage, flash memory, random access memory (RAM-SRAM, EDO RAM, SDRAM, DDR SDRAM, RAMBUS RAM, or the like), read only memory (PROM, EEPROM, or the like), or the like. Memory in compute system 100 is not limited to primary storage such as memory 120. Compute system 100 can also include other forms of storage such as cache memory in processor subsystem 110 and secondary storage on I/O device 140 (e.g., a hard drive, storage array, etc.). In some embodiments, these other forms of storage can also store program instructions executable by processor subsystem 110 to perform operations described herein. In some embodiments, processor subsystem 110 (or each processor within processor subsystem 110) contains a cache or other form of on-board memory.

I/O interface 130 can be any of various types of interfaces configured to communicate with other devices. In some embodiments, I/O interface 130 includes a bridge chip (e.g., Southbridge) from a front-side bus to one or more back-side buses. I/O interface 130 can communicate with one or more I/O devices (e.g., I/O device 140) via one or more corresponding buses or other interfaces. Examples of I/O devices include storage devices (hard drive, optical drive, removable flash drive, storage array, SAN, or their associated controller), network interface devices (e.g., to a local or wide-area network), sensor devices (e.g., camera, radar, LiDAR, ultrasonic sensor, GPS, inertial measurement device, or the like), and auditory or visual output devices (e.g., speaker, light, screen, projector, or the like). In some embodiments, compute system 100 is communicating with a network via a network interface device (e.g., configured to communicate over Wi-Fi, Bluetooth, Ethernet, or the like). In some embodiments, compute system 100 is directly or wired to the network.

Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, software modules, and/or components.

Implementations within the scope of the present disclosure include a computer-readable storage medium that encodes instructions organized as an application (e.g., application 170) that, when executed by one or more processing units, control an electronic device (e.g., device 168) to perform the process of FIG. 1B, the process of FIG. 1C, and/or one or more other processes and/or processes described herein.

It should be recognized that application 170 (e.g., illustrated in FIG. 1D) can be any suitable type of application, including, for example, one or more of: a browser application, an application that functions as an execution environment for plug-ins, widgets, or other applications, a fitness application, a health application, an accessory management application, a home application, a digital payments application, a media application, a social network application, a messaging application, and/or a maps application. In some embodiments, application 170 is an application that is pre-installed on device 168 at purchase (e.g., a first party application). In some embodiments, application 170 is an application that is provided to device 168 via an operating system update file (e.g., a first party application or a second party application). In other embodiments, application 170 is an application that is provided via an application store. In some embodiments, the application store can be an application store that is pre-installed on device 168 at purchase (e.g., a first party application store). In some embodiments, the application store is a third-party application store (e.g., an application store that is provided by another application store, downloaded via a network, and/or read from a storage device).

Referring to FIG. 1B and FIG. 1F, application 170 obtains information (e.g., 160). In some embodiments, at 160, information is obtained from at least one hardware component of device 168. In some embodiments, at 160, information is obtained from at least one software module (e.g., a set of one more instructions) of device 168. In some embodiments, at 160, information is obtained from at least one hardware component external to device 168 (e.g., a peripheral device, an accessory device, and/or a server). In some embodiments, the information obtained at 160 includes positional information, time information, notification information, user information, environment information, electronic device state information, weather information, media information, historical information, event information, hardware information, and/or motion information. In some embodiments, in response to and/or after obtaining the information at 160, application 170 provides the information to system (e.g., 162).

In some embodiments, the system (e.g., 180 as illustrated in FIG. 1E) is an operating system hosted on device 168. In some embodiments, the system (e.g., 180 as illustrated in FIG. 1E) is an external device (e.g., a server, a peripheral device, an accessory, and/or a personal computing device) that includes an operating system.

Referring to FIG. 1C, application 170 obtains information (e.g., 164). In some embodiments, the information obtained at 164 includes positional information, time information, notification information, user information, environment information electronic device state information, weather information, media information, historical information, event information, hardware information and/or motion information. In response to and/or after obtaining the information at 164, application 170 performs an operation with the information (e.g., 166). In some embodiments, the operation performed at 166 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 180 based on the information.

In some embodiments, one or more steps of the process of FIG. 1B and/or the process of FIG. 1C is performed in response to a trigger. In some embodiments, the trigger includes detection of an event, a notification received from system 180, a user input, and/or a response to a call to an API provided by system 180.

In some embodiments, the instructions of application 170, when executed, control device 168 to perform the process of FIG. 1B and/or the process of FIG. 1C by calling an application programming interface (API) (e.g., API 176) provided by system 180. In some embodiments, application 170 performs at least a portion of the process of FIG. 1B and/or the process of FIG. 1C without calling API 176.

In some embodiments, one or more steps of the process of FIG. 1B and/or the process of FIG. 1C includes calling an API (e.g., API 176) using one or more parameters defined by the API. In some embodiments, the one or more parameters include a constant, a key, a data structure, an object, an object class, a variable, a data type, a pointer, an array, a list or a pointer to a function or a process, and/or another way to reference a data or other item to be passed via the API.

Referring to FIG. 1D, device 168 is illustrated. In some embodiments, device 168 is a personal computing device, a smart phone, a smart watch, a fitness tracker, a head mounted display (HMD) device, a media device, a communal device, a speaker, a television, and/or a tablet. Device 168 includes application 170 and an operating system (not shown) (e.g., system 180 as illustrated in FIG. 1E). Application 170 includes application implementation instructions 172 and API calling instructions 174. System 180 includes API 176 and implementation instructions 178. It should be recognized that device 168, application 170, and/or system 180 can include more, fewer, and/or different components than illustrated in FIGS. 1D and 1E.

In some embodiments, application implementation instructions 172 is a software module that includes a set of one or more computer-readable instructions. In some embodiments, the set of one or more computer-readable instructions correspond to one or more operations performed by application 170. For example, when application 170 is a messaging application, application implementation instructions 172 can include operations to receive and send messages. In some embodiments, application implementation instructions 172 communicates with API calling instructions to communicate with system 180 via API 176 (e.g., as illustrated in FIG. 1E).

In some embodiments, API calling instructions 174 is a software module that includes a set of one or more computer-executable instructions.

In some embodiments, implementation instructions 178 is a software module that includes a set of one or more computer-executable instructions.

In some embodiments, API 176 is a software module that includes a set of one or more computer-executable instructions. In some embodiments, API 176 provides an interface that allows a different set of instructions (e.g., API calling instructions 174) to access and/or use one or more functions, processes, procedures, data structures, classes, and/or other services provided by implementation instructions 178 of system 180. For example, API calling instructions 174 can access a feature of implementation instructions 178 through one or more API calls or invocations (e.g., embodied by a function call, a method call, or a process call) exposed by API 176 and can pass data and/or control information using one or more parameters via the API calls or invocations. In some embodiments, API 176 allows application 170 to use a service provided by a Software Development Kit (SDK) library. In some embodiments, application 170 incorporates a call to a function or process provided by the SDK library and provided by API 176 or uses data types or objects defined in the SDK library and provided by API 176. In some embodiments, API calling instructions 174 makes an API call via API 176 to access and use a feature of implementation instructions 178 that is specified by API 176. In such embodiments, implementation instructions 178 can return a value via API 176 to API calling instructions 174 in response to the API call. The value can report to application 170 the capabilities or state of a hardware component of device 168, including those related to aspects such as input capabilities and state, output capabilities and state, processing capability, power state, storage capacity and state, and/or communications capability. In some embodiments, API 176 is implemented in part by firmware, microcode, or other low level logic that executes in part on the hardware component.

In some embodiments, API 176 allows a developer of API calling instructions 174 (which can be a third-party developer) to leverage a feature provided by implementation instructions 178. In such embodiments, there can be one or more sets of API calling instructions (e.g., including API calling instructions 174) that communicate with implementation instructions 178. In some embodiments, API 176 allows multiple sets of API calling instructions written in different programming languages to communicate with implementation instructions 178 (e.g., API 176 can include features for translating calls and returns between implementation instructions 178 and API calling instructions 174) while API 176 is implemented in terms of a specific programming language. In some embodiments, API calling instructions 174 calls APIs from different providers such as a set of APIs from an OS provider, another set of APIs from a plug-in provider, and/or another set of APIs from another provider (e.g., the provider of a software library) or creator of the another set of APIs.

Examples of API 176 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments the sensor API is an API for accessing data associated with a sensor of device 168. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation instructions 178 is a system (e.g., an operating system and/or a server system) software module (e.g., a collection of computer-readable instructions) that is constructed to perform an operation in response to receiving an API call via API 176. In some embodiments, implementation instructions 178 is constructed to provide an API response (via API 176) as a result of processing an API call. By way of example, implementation instructions 178 and API calling instructions 174 can each be any one of an operating system, a library, a device driver, an API, an application program, or other module. It should be understood that implementation instructions 178 and API calling instructions 174 can be the same or different type of software module from each other. In some embodiments, implementation instructions 178 is embodied at least in part in firmware, microcode, or other hardware logic.

In some embodiments, implementation instructions 178 returns a value through API 176 in response to an API call from API calling instructions 174. While API 176 defines the syntax and result of an API call (e.g., how to invoke the API call and what the API call does), API 176 might not reveal how implementation instructions 178 accomplishes the function specified by the API call. Various API calls are transferred via the one or more application programming interfaces between API calling instructions 174 and implementation instructions 178. Transferring the API calls can include issuing, initiating, invoking, calling, receiving, returning, and/or responding to the function calls or messages. In other words, transferring can describe actions by either of API calling instructions 174 or implementation instructions 178. In some embodiments, a function call or other invocation of API 176 sends and/or receives one or more parameters through a parameter list or other structure.

In some embodiments, implementation instructions 178 provides more than one API, each providing a different view of or with different aspects of functionality implemented by implementation instructions 178. For example, one API of implementation instructions 178 can provide a first set of functions and can be exposed to third party developers, and another API of implementation instructions 178 can be hidden (e.g., not exposed) and provide a subset of the first set of functions and also provide another set of functions, such as testing or debugging functions which are not in the first set of functions. In some embodiments, implementation instructions 178 calls one or more other components via an underlying API and thus be both an API calling instructions and an implementation instructions. It should be recognized that implementation instructions 178 can include additional functions, processes, classes, data structures, and/or other features that are not specified through API 176 and are not available to API calling instructions 174. It should also be recognized that API calling instructions 174 can be on the same system as implementation instructions 178 or can be located remotely and access implementation instructions 178 using API 176 over a network. In some embodiments, implementation instructions 178, API 176, and/or API calling instructions 174 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

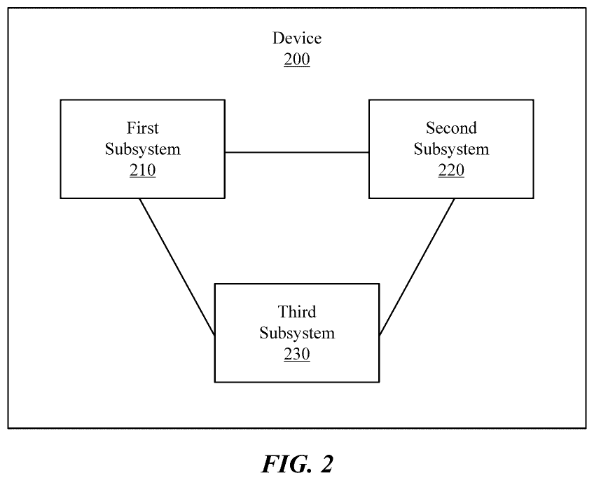

FIG. 2 illustrates a block diagram of device 200 with interconnected subsystems. In the illustrated example, device 200 includes three different subsystems (i.e., first subsystem 210, second subsystem 220, and third subsystem 230) communicating with (e.g., wired or wirelessly) each other, creating a network (e.g., a personal area network, a local area network, a wireless local area network, a metropolitan area network, a wide area network, a storage area network, a virtual private network, an enterprise internal private network, a campus area network, a system area network, and/or a controller area network). An example of a possible computer architecture of a subsystem as included in FIG. 2 is described in FIG. 1A (i.e., compute system 100). Although three subsystems are shown in FIG. 2, device 200 can include more or fewer subsystems.

In some embodiments, some subsystems are not connected to other subsystem (e.g., first subsystem 210 can be connected to second subsystem 220 and third subsystem 230 but second subsystem 220 cannot be connected to third subsystem 230). In some embodiments, some subsystems are connected via one or more wires while other subsystems are wirelessly connected. In some embodiments, messages are set between the first subsystem 210, second subsystem 220, and third subsystem 230, such that when a respective subsystem sends a message the other subsystems receive the message (e.g., via a wire and/or a bus). In some embodiments, one or more subsystems are wirelessly connected to one or more compute systems outside of device 200, such as a server system. In such examples, the subsystem can be configured to communicate wirelessly to the one or more compute systems outside of device 200.

In some embodiments, device 200 includes a housing that fully or partially encloses subsystems 210-230. Examples of device 200 include a home-appliance device (e.g., a refrigerator or an air conditioning system), a robot (e.g., a robotic arm or a robotic vacuum), and a vehicle. In some embodiments, device 200 is configured to navigate (with or without user input) in a physical environment.

In some embodiments, one or more subsystems of device 200 are used to control, manage, and/or receive data from one or more other subsystems of device 200 and/or one or more compute systems remote from device 200. For example, first subsystem 210 and second subsystem 220 can each be a camera that captures images, and third subsystem 230 can use the captured images for decision making. In some embodiments, at least a portion of device 200 functions as a distributed compute system. For example, a task can be split into different portions, where a first portion is executed by first subsystem 210 and a second portion is executed by second subsystem 220.

Attention is now directed towards techniques for detecting motion. Such techniques are described in the context of motion detection. It should be recognized that other types of data can be used with techniques described herein. For example, sensor data (e.g., ultrasonic sensor data, passive infrared (PIR) sensor data, depth sensor data, and/or thermal sensor data) and/or home automation system logs can provide addition motion detection signals using techniques described herein. In addition, techniques optionally complement or replace other techniques for detecting motion.

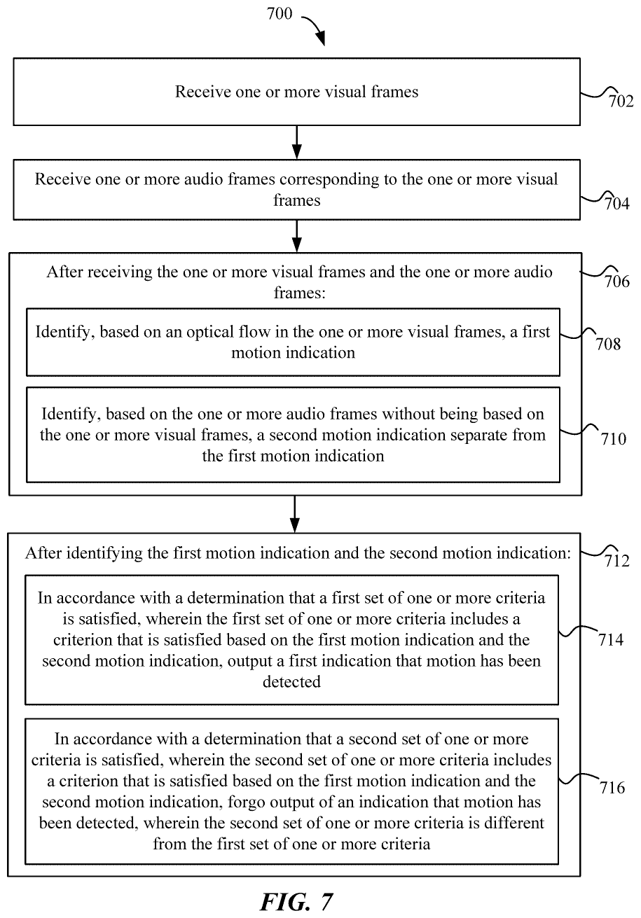

FIG. 3 illustrates an exemplary process for training an audio-based motion detection model in accordance with some embodiments. The process in this figure is used to illustrate a technique for training a model used with processes described below, including the processes in FIGS. 7-9.

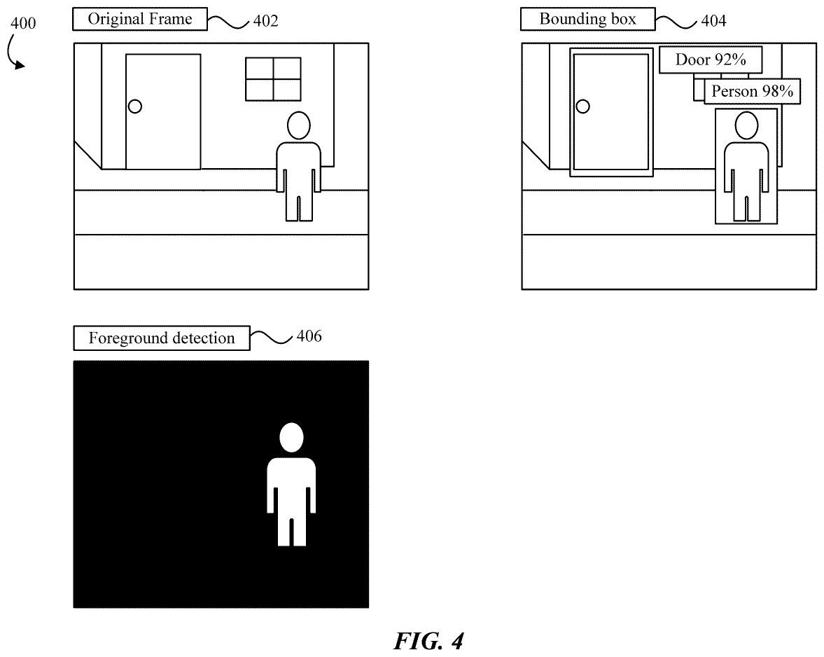

In some embodiments, process 300 includes performing training (e.g., offline and/or online training) of audio-based motion detection model 314 using video data 302a and audio data 302b received via data sources 302. For example, process 300 includes generating labeled data set 312 by processing video data 302a through a vision-based detection model to determine when motion should be detected in corresponding audio data (e.g., audio data 302b). The labeled data set 312 can then be used to train audio-based motion detection model 314 for motion detection using only audio data. In some embodiments, audio-based motion detection model 314 captures motion-detection capabilities of a vision-based detection model while requiring less computational resources to be used. It should be recognized that audio-based motion detection model 314 can be combined with one or more different types of vision-based detection models to better detect motion, as further discussed below with respect to FIGS. 4-6.

As illustrated in FIG. 3, process 300 includes receiving input from data sources 302. In some embodiments, the input from data sources 302 include video data 302a and audio data 302b captured via one or more devices, components, sensors, and/or sources. For example, video data 302a and/or audio data 302b can be obtained from a camera, a microphone, a surveillance camera, a home security camera, a smart doorbell, a mobile device, and/or other video and/or audio capture device. In some embodiments, data sources 302 are stored in a computer system that is executing process 300. In some embodiments, data sources 302 are stored in one or more databases, cloud storage systems, local storage devices, and/or distributed storage systems.

In some embodiments, data sources 302 include historical data collected over a number of time periods, environmental conditions, geographical locations, and/or device types to ensure diversity in data sources 302. In some embodiments, data sources 302 includes video samples and/or audio samples captured with different subjects, objects, and/or environments at different locations, during different times of day, in different weather conditions, and/or using different camera models. For example, video data 302a can include video samples of delivery personnel approaching with packages on different surface materials (e.g., concrete, gravel, and/or grass). For another example, video data 302a can include video samples of multiple people simultaneously walking at different distances from a camera to train on scenarios with multiple motion sources at varying scales. For another example, audio data 302b can include audio samples of cars moving during rainfall and/or different wind conditions to allow for training on sounds of different types of motion that can be distinguished from environmental noise. For another example, audio data 302b can include audio samples of overlapping motion sounds from concurrent events with a number of subjects and/or objects (e.g., footsteps during door closing while a car passes by and/or a dog barking while walking through dried leaves) to train identification of distinct motion sources based on different characteristics in audio data.

It should be recognized that, in addition to or instead of video data 302a and audio data 302b, data sources 302 can include data from other input modalities such as home automation system activity logs, an ultrasonic sensor, a passive infrared (PIR) sensor, a depth sensor, a thermal sensor, and/or radar sensor to provide other motion detection signals. For example, home automation system activity logs can indicate a door lock state change to suggest likely motion near a door. For another example, PIR sensors can detect motion through heat signatures.

In some embodiments, video data 302a is filtered and/or normalized before being used to train audio-based motion detection model 314. For example, video data 302a can be sampled to a normalized frame rate (e.g., 29.7 frames per second or 60 frames per second) and/or resolution (e.g., 1280×720 or 1920×1080 pixels) for uniform processing. For another example, video data 302a can undergo color space normalization where pixel values are converted to a standardized color space (e.g., RGB to YUV) and/or normalized to a specific range (e.g., 0-1).

In some embodiments, audio data 302b is filtered and/or normalized before being used to train audio-based motion detection model 314. For example, audio data 302b can be sampled to a normalized sampling rate (e.g., 44.1 kHz or 48 kHz) and/or bit depth (e.g., 16-bit or 24-bit). For another example, audio data 302b can undergo amplitude normalization for consistent volume levels across different audio samples. For another example, audio data 302b can be filtered to focus on frequency ranges most relevant to motion detection. For another example, audio data 302b can undergo noise reduction processing to minimize background noise while preserving motion-related sounds.

In some embodiments, process 300 includes extracting video frames from video data 302a. For example, process 300 can include processing video data 302a to obtain consecutive frames 304. In some embodiments, consecutive frames 304 include multiple video frames (e.g., 2 or more, such as 4 in some embodiments) that are sequential in a video sequence. In some embodiments, consecutive frames 304 are separated by a predetermined time interval based on a frame rate of video data 302a. In some embodiments, consecutive frames 304 are separated by a predetermined time interval selected to capture motion changes detectable by a vision-based detection model (e.g., changes visible within 16.67 milliseconds, 33.67 milliseconds, 1.5 second, or 2 seconds).

In some embodiments, process 300 includes extracting audio of consecutive frames from audio data 302b. In such embodiments, the audio of consecutive frames can correspond to consecutive frames 304 such that each video frame in consecutive frames 304 has corresponding audio. For example, process 300 can include processing audio data 302b to obtain audio of consecutive frames 306. In some embodiments, audio of consecutive frames 306 is extracted using a sliding window technique, where a window size matches a time interval between consecutive frames 304. In some embodiments, audio of consecutive frames 306 represents an audio segment that temporally aligns with audio between a first frame and a second frame of consecutive frames 304. For example, when processing a video at 29.97 frames per second, process 300 can include extracting an audio segment of 66.73 milliseconds that corresponds to a time interval between two consecutive frames of consecutive frames 304. For another example, when processing a video at a frame rate of 60 frames per second, process 300 can include extracting an audio segment of 16.67 milliseconds that corresponds to a time interval between two consecutive frames of consecutive frames 304. In some embodiments, audio of consecutive frames 306 is extracted with an overlap between consecutive windows to capture motion-related sounds that span frame boundaries. In some embodiments, audio of consecutive frames 306 is synchronized with consecutive frames 304 using timestamp information from video data 302a. In some embodiments, process 300 includes verifying temporal alignment between audio of consecutive frames 306 and consecutive frames 304 using metadata from data sources 302, such as device timestamps and/or frame indices.

In some embodiments, consecutive frames 304 are processed by a vision-based detection model to generate vision detection model output 308. In some embodiments, the vision-based detection model used to generate vision detection model output 308 is a state-of-the-art model that achieves high performance on object detection and classification benchmarks such as Common Objects in Context (COCO) dataset. For example, a state-of-the-art model can currently achieve a mean Average Precision (mAP) score above 65% on the COCO benchmark for object detection. In some embodiments, using a state-of-the-art vision model to generate vision detection model output 308 allows for generating high-quality ground truth labels for training audio-based motion detection model 314, as accuracy of these ground truth labels directly impacts the audio model's ability to generalize to different motion detection conditions. In some embodiments, the vision-based detection model can be updated with newer models that achieve better benchmark performance to maintain state-of-the-art accuracy in motion detection labeling.

In some embodiments, the vision-based detection model performs instance segmentation for motion detection. In such embodiments, the vision-based detection model can be trained on large-scale image datasets to detect and classify a large number of object classes, such as a person, dog, bottle, car, door, balloon, and/or bicycle. In some embodiments, the vision-based detection model processes consecutive frames 304 through multiple processing stages to generate vision detection model output 308. In some embodiments, a first processing stage extract hierarchical feature maps from consecutive frames 304 using a convolutional neural network (CNN). For example, the CNN can extract features, such as edges, shapes, and/or textures, from consecutive frames 304 to help identify objects. In some embodiments, in addition to the first processing stage, a second processing stage generates region proposals identifying potential objects of interest using a Region Proposal Network (RPN). For example, the RPN can identify rectangular regions that likely contain objects, such people, vehicles, and/or animals. In some embodiments, in addition to the first processing stage and/or the second processing stage, a third processing stage predicts segmentation masks for detected objects using mask prediction heads. For example, for a detected person, mask prediction can outline a shape of a detected person rather than just a rectangular box. In some embodiments, the vision-based detection model compares object positions, bounding boxes, and/or segmentation masks between consecutive frames 304, such as a first mask corresponding to objects detected in a first frame and a second mask corresponding to objects detected in a second frame of consecutive frames 304, to determine if significant motion has occurred.

In some embodiments, vision detection model output 308 includes a binary decision indicating whether significant motion occurred with respect to a single frame, between multiple frames, and/or with respect to consecutive frames 304. For example, vision detection model output 308 can include a value of 1 to indicate that significant motion is detected or a value of 0 to indicate that no significant motion is detected.

In some embodiments, vision detection model output 308 includes metadata such as motion confidence scores, object classifications, and/or motion vectors. For example, vision detection model output 308 can include numeric class indices from 0 to 6,000 representing detected object types with corresponding probability scores (e.g., class index 3 with 0.97 probability for person detection). For another example, vision detection model output 308 can include a two-dimensional array of binary values representing detected object masks along with corresponding class labels and/or confidence scores.

In some embodiments, process 300 includes processing audio of consecutive frames 306 to generate numerical vector of audio 310. In such embodiments, the processing can include feature extraction on audio of consecutive frames 306 using Mel-frequency Cepstral Coefficients (MFCCs) to generate numerical vector of audio 310. In some embodiments, MFCCs are computed by taking a Fourier transform of audio of consecutive frames 306, mapping powers of the spectrum onto Mel scale using triangular overlapping windows, taking the logs of the powers at each Mel frequency, and taking the discrete cosine transform of the list of Mel log powers. In some embodiments, numerical vector of audio 310 includes 13 or more MFCC coefficients that represent spectral characteristics of audio of consecutive frames 306. For example, process 300 can include computing spectral features such as spectral centroid, spectral rolloff, spectral flux, and/or spectral bandwidth from audio of consecutive frames 306. For another example, process 300 can include computing temporal features such as zero-crossing rate, root mean square energy, and/or temporal envelope from audio of consecutive frames 306. For another example, process 300 can include applying wavelet transforms to extract time-frequency representations from audio of consecutive frames 306. For another example, process 300 can include using an embedding model to generate latent vector representations of audio of consecutive frames 306. In some embodiments, process 300 includes combining multiple feature extraction techniques to generate numerical vector of audio 310 with diverse audio characteristics.

In some embodiments, numerical vector of audio 310 includes information about an intensity and/or distribution of sound across a number of frequencies that allows differentiation between motion-related sounds from a number of sources and/or distances. In some embodiments, numerical vector of audio 310 includes ranges of numerical values that correspond to a number of types of sounds in an audio signal. For example, numerical vector of audio 310 can include values in specific ranges (e.g., coefficient values between −50 and 50 for a first coefficient representing low-frequency components of an audio signal in a range of 20 Hz to 200 Hz that often correspond to background sounds) that make it possible to distinguish between footsteps of a person approaching a camera and a sound of a car pulling into a driveway, even when these sounds occur simultaneously. For another example, numerical vector of audio 310 can include patterns of values (e.g., decreasing amplitude patterns in coefficients that represent frequencies above 2 kHz, where the decrease in amplitude across high-frequency coefficients can indicate sound absorption by air over distance) that indicate how far a sound source is from a recording device based on sound attenuation patterns. In some embodiments, process 300 includes analyzing ranges of values within numerical vector of audio 310 (e.g., first through fifth MFCC coefficients versus tenth through thirteenth coefficients) to identify distinct motion-related sounds occurring concurrently in audio of consecutive frames 306. For example, one range of values in numerical vector of audio 310 (e.g., coefficients 1-5) can correspond to vehicle engine sounds while another range (e.g., coefficients 6-9) can correspond to footstep sounds.

In some embodiments, process 300 includes generating labeled dataset 312 by combining vision detection model output 308 with numerical vector of audio 310. In some embodiments, labeled dataset 312 includes pairs of data, where each pair includes a numerical vector representing audio characteristics and a corresponding binary label (e.g., 0 or 1) that indicates whether significant motion occurred during an audio segment. In some embodiments, binary labels in labeled dataset 312 are derived from vision detection model output 308 that serves as ground truth for whether motion occurred with respect to a single frame, between multiple frames, and/or with respect to consecutive frames 304. For example, if vision detection model output 308 indicates motion at a first frame of consecutive frames 304 with a value of 1, numerical vector of audio 310 corresponding to the first frame is paired with a label of 1 in labeled dataset 312. In some embodiments, labeled dataset 312 maintains temporal alignment between audio features and motion labels. In some embodiments, each numerical vector in labeled dataset 312 corresponds to an exact time period where vision detection model output 308 detected motion or lack of motion. For example, for a video at 29.97 frames per second, a numerical vector representing 33.67 milliseconds of audio can be paired with a motion detection label for that same 33.67 millisecond period. In some embodiments, labeled dataset 312 includes metadata from vision detection model output 308 such as motion confidence scores, object classifications, and/or motion vectors to provide additional heuristics for training.

In some embodiments, labeled dataset 312 enables training of audio-based motion detection model 314 to identify correlations between audio patterns and motion events. In some embodiments, labeled dataset 312 includes examples where specific ranges of MFCC coefficients in numerical vector of audio 310 correspond to motion detection labels from vision detection model output 308. For example, labeled dataset 312 can include cases where strong coefficients in a footstep frequency range (e.g., coefficients 6-9) correspond to vision-detected motion of a person. For another example, labeled dataset 312 can include cases where patterns of decreasing amplitude in high-frequency coefficients correspond to vision-detected motion at different distances from a camera. In some embodiments, labeled dataset 312 includes examples of simultaneous motion events, where multiple ranges of coefficient values in numerical vector of audio 310 correspond to vision detection model output 308 indicating multiple moving objects.

In some embodiments, labeled dataset 312 captures high-accuracy motion detection capabilities of the vision-based detection model in a format that can be used to train audio-based motion detection model 314 that is more computationally efficient than the vision-based detection model. In some embodiments, labeled dataset 312 includes a diverse range of motion scenarios captured by the vision-based detection model that allow audio-based motion detection model 314 to learn a large number of associations between audio patterns and motion events.

In some embodiments, process 300 includes using labeled dataset 312 to train audio-based motion detection model 314 in an offline training process. In such embodiments, audio-based motion detection model 314 can be trained using supervised learning techniques to learn patterns in numerical vectors of audio that correlate with motion detection labels in vision detection model output 308, by minimizing a loss function that measures differences between model predictions and these ground truth labels.

In some embodiments, audio-based motion detection model 314 is a neural network with multiple layers for processing numerical vectors of audio. In such embodiments, a first layer of the neural network can include input nodes that each correspond to a coefficient in numerical vector of audio 310 (e.g., 13 input nodes for 13 MFCC coefficients). In such embodiments, one or more hidden layers can process these input nodes using a number of architectures. For example, the one or more hidden layers can include dense layers with nodes fully connected to adjacent layers, where each connection has a learned weight that is adjusted during training. For another example, the one or more hidden layers can include convolutional layers that apply learned filters across groups of coefficients to detect patterns across frequency ranges. For another example, the one or more hidden layers can include recurrent layers that maintain state information across sequential audio segments to capture temporal patterns in the coefficients. In some embodiments, dropout layers are included between hidden layers, where random nodes are deactivated during training to prevent overfitting. In some embodiments, batch normalization layers are included to normalize activation values across training batches and/or improve training stability. In some embodiments, an output layer produces a binary classification (e.g., 0 or 1) indicating presence or absence of motion.

In some embodiments, labeled dataset 312 is split into training, validation, and testing sets to evaluate model performance (e.g., 80% for training, 10% for validation, and 10% for testing). In some embodiments, process 300 includes using techniques, such as k-fold cross-validation (e.g., k=5 or k=10) and early stopping (e.g., stopping after validation loss fails to improve for 5 consecutive epochs), to prevent overfitting and/or ensure generalization of audio-based motion detection model 314 to new scenarios. For example, using k-fold cross-validation with k=5, audio-based motion detection model 314 can be trained 5 separate times using 4 parts for training and 1 part for validation, rotating which part is used for validation each time to ensure that audio-based motion detection model 314 performs consistently across different subsets of labeled dataset 312.

In some embodiments, audio-based motion detection model 314 is optimized for deployment on devices with limited computational resources. In such embodiments, audio-based motion detection model 314 can requires fewer computational resources compared to a vision-based detection model. For example, while a vision-based detection model can require approximately 200 megabytes for a base library and an additional 250 or 350 megabytes for model weights, audio-based motion detection model 314 can require only 50 megabytes for a base library and would not require additional memory for model weights. For another example, while a vision-based detection model can require approximately between 4 and 8 gigabytes of Graphical Processing Unit (GPU) memory, audio-based motion detection model 314 might not require any GPU memory for operation since processing numerical vectors through neural network layers with limited input nodes (e.g., 13 nodes for MFCC coefficients) and simple activation functions involves mathematical operations can be efficiently performed using a Central Processing Unit (CPU) rather than requiring parallel processing capabilities of a GPU. For another example, while a vision-based detection model can require approximately between 8 and 16 gigabytes of system memory, audio-based motion detection model 314 can require only between 200 and 600 megabytes of system memory.

In some embodiments, audio-based motion detection model 314 is periodically updated using new training data collected from deployed devices. For example, process 300 can include establishing a pipeline to continue taking in audio data and/or video data to improve audio-based motion detection model 314 with real-world data at a recurring frequency.

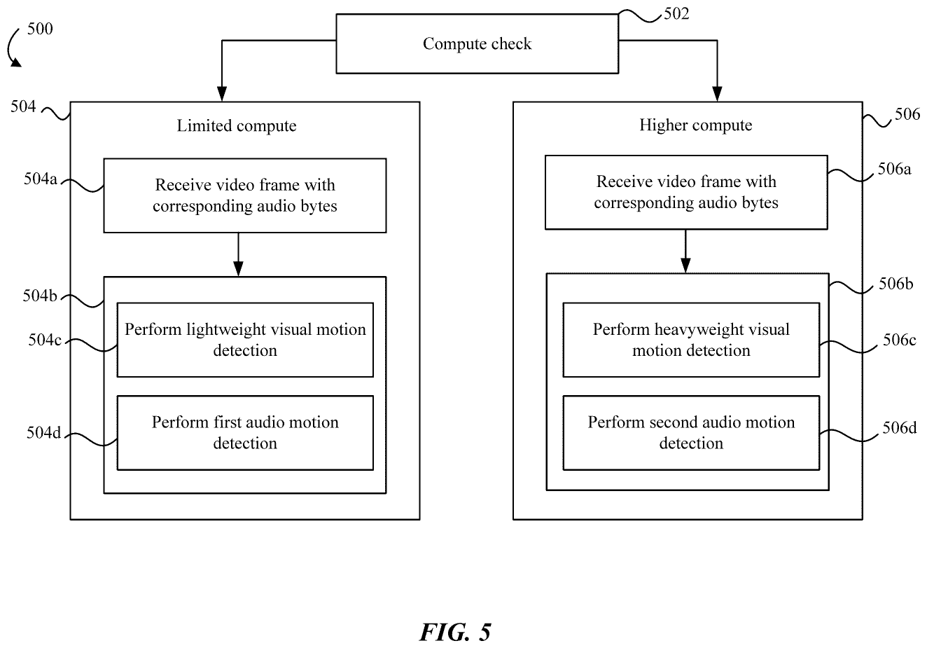

FIG. 4 illustrates an exemplary process for detecting motion in a video frame using a vision-based motion detection technique in accordance with some embodiments. In particular, process 400 demonstrates instance segmentation that, in some embodiments, forms a portion of a visual-based motion detection described later with respect to FIG. 5 and provides ground truth for training audio-based motion detection model 314 during process 300 as described above with respect to FIG. 3.

As illustrated in FIG. 4, process 400 includes three stages in instance segmentation: original frame 402 illustrating a raw input frame, bounding box detection 404 illustrating object detection and classification, and foreground detection 406 illustrating foreground-background separation. In some embodiments, all three stages are used when motion detection with object understanding is required (e.g., distinguishing between motion of a person and motion of tree leaves). In some embodiments, only a subset of stages is used in a scenario of a limited compute resource or when precise object classification is not required for motion detection.

In some embodiments, original frame 402 represents a raw input frame for instance segmentation. In some embodiments, one or more pre-processing steps, such as resolution standardization and/or color space conversion, are applied to original frame 402 as described above with respect to video data 302a in FIG. 3. In some embodiments, original frame 402 undergoes additional preprocessing specific to instance segmentation. For example, original frame 402 can be processed to generate feature pyramids at multiple scales (e.g., ¼, ⅛, or 1/16 of original resolution) to enable detection of objects at varying distances from a video recording source and/or enable efficient processing by matching object scales to appropriate feature resolutions rather than processing an entire frame at full resolution. In such an example, smaller scale features (e.g., 1/16 resolution) can help detect large and/or close objects while larger scale features (e.g., ¼ resolution) and/or help detect small and/or distant objects to back reliable motion detection across a range of depths in a frame and/or scene. In some embodiments, original frame 402 undergoes one or more additional preprocessing steps based on available computational resources. For example, with a high-compute resource, original frame 402 can undergo image enhancement techniques, such as contrast adjustment, noise reduction, and/or sharpening, to improve feature detection quality. In some embodiments, when computational resources are limited, original frame 402 processing is restricted to essential steps, such as using a single scale, a single-color space, and/or skipping enhancement techniques to reduce computational overhead.

In some embodiments, bounding box detection 404 represents a result of object detection and/or localization within original frame 402 as part of instance segmentation. In some embodiments, bounding box detection 404 is performed using a Region Proposal Network (RPN) that identifies regions in a frame that are likely to contain foreground objects rather than background elements by using anchor boxes of different scales and aspect ratios across the frame. For example, the RPN can use small anchor boxes (e.g., 32×32 pixels) to detect compact objects, such as a small animal, and large anchor boxes (e.g., 256×256 pixels) to detect larger objects, such as a vehicle. In some embodiments, the RPN applies different aspect ratios to the anchor boxes (e.g., 1:1 ratio for square objects, 1:2 ratio for vertical objects such as a standing person, or 2:1 ratio for horizontal objects such as cars) to better match natural object shapes in a frame. In some embodiments, anchor boxes serve as initial region proposals that the RPN refines based on learned features to locate areas that deserve further analysis for object detection and/or classification.

In some embodiments, for each anchor box in a frame, the RPN computes an objectness score that indicates likelihood of a region containing a particular object. In some embodiments, bounding box detection 404 is performed by processing the region identified by the RPN through classification branches to identify object categories. For example, each region can be processed through multiple neural network layers that extract increasingly specific features, such as a first branch detecting general object characteristics (e.g., shape, size, and/or edges), a second branch identifying an object class (e.g., person, animal, vehicle, or door), and a third branch computing confidence scores for each possible object class. In some embodiments, bounding box detection 404 is performed by identifying object classes with corresponding confidence scores, such as a person with 98% confidence and a door with 92% confidence as illustrated in 404.

In some embodiments, boundary coordinates of an anchor box are refined using regression techniques to better fit a shape of a detected object. For example, coordinates of an initial anchor box are adjusted using learned offset values, such as adjustments to x and/or y coordinates for center position and/or adjustments to width and/or height for dimensions, to tighten box boundaries around an area where object features are detected (e.g., regions where convolutional layers have detected object-specific patterns such as edges of a person's silhouette or contours of a door frame, rather than regions with uniform textures and/or patterns typical of background elements such as walls and/or floors) to remove excessive background pixels and enable precise object localization.

In some embodiments, bounding box detection 404 enables analysis of spatial relationships between detected objects across consecutive frames to determine patterns of motion between objects. In some embodiments, comparing bounding box positions, sizes, and/or orientations between a first frame and a second frame informs object motion. For example, calculating pixel distances between centroids of bounding boxes to measure relative object positions, computing intersection-over-union (IoU) scores between bounding boxes in consecutive frames to track object movement, and/or measuring changes in bounding box dimensions indicate relative position changes between objects and directional motion. For another example, when a person and a door are detected, tracking changes in an IoU score of a bounding box of the person relative to a bounding box of the door across frames can indicate whether the person is moving toward or away from the door.

In some embodiments, bounding box detection 404 is performed using different levels of spatial analysis based on available compute resources. For example, with high-compute resources, bounding box detection 404 can be performed by maintaining a temporal buffer of bounding box coordinates across multiple frames (e.g., storing coordinates, dimensions, and object class information for each detected object over 30 frames) to compute complex motion trajectories and/or acceleration patterns. For another example, with limited-compute resources, bounding box detection 404 can be performed by only comparing bounding boxes between consecutive frames and restricting analysis to simple displacement calculations (e.g., measuring only a change in x and y coordinates of bounding box centroids between two frames to determine basic direction and/or speed of motion) for a limited number of detected objects (e.g., prioritizing tracking of people and/or vehicles over objects such trees and/or small animals).

In some embodiments, foreground detection 406 illustrates a process for separating foreground elements from background elements using instance segmentation results. In some embodiments, foreground detection 406 uses pixel-level masks generated from bounding box detection 404 to simplify motion detection by reducing a problem space from analyzing all pixels in a frame to analyzing only pixels identified as potentially belonging to foreground elements. In some embodiments, foreground detection 406 is performed by applying Gaussian Mixture Models (GMM) to model background pixels and identify foreground elements.

In some embodiments, foreground detection 406 maintains different background modeling approaches based on available computational resources. For example, with a high-compute resource, foreground detection 406 can maintain multiple Gaussian distributions per pixel to model different background states for detecting foreground elements in dynamic scenes where background elements change appearance (e.g., shadows moving across a scene and/or trees swaying in wind). In such an example, each pixel can be modeled using three distributions, where each distribution is characterized by a mean color value, variance, and/or a relative importance value between 0 and 1 that indicates how often an appearance of a background element is observed, where a sum of all importance values for a pixel equals 1 to maintain a valid probability distribution that represents all possible background states for that pixel location. In some embodiments, these distributions collectively model a probability distribution of a pixel's typical background color variations over time. For another example, with a limited-compute resource, foreground detection 406 can use a single Gaussian distribution per pixel and updates the distribution's mean color value and/or variance less frequently (e.g., every 5 or 10 frames rather than at every frame) to reduce computational overhead while maintaining basic foreground-background separation capability.

In some embodiments, foreground detection 406 integrates instance segmentation results from bounding box detection 404 to adjust processing within different regions of a frame. For example, foreground detection 406 can adjust GMM distribution parameters based on detected object classes and/or regions defined by bounding boxes. In such an example, within bounding boxes where a person and/or a vehicle is detected with high confidence (e.g., above 90%), foreground detection 406 can make foreground detection more sensitive to subtle movements of these objects by requiring matches with fewer Gaussian distributions to classify a pixel as a foreground element (e.g., requiring a pixel's values to match only 2 out of 3 background Gaussian distributions rather than all 3 distributions, where failing to match enough background distributions results in the pixel being classified as part of a foreground element). For another example, in regions where background objects are detected (e.g., trees and/or curtains), foreground detection 406 can require matches with more Gaussian distributions to classify a pixel as a foreground element to minimize false foreground detection due to natural background motion. In some embodiments, region-specific parameter adjustment is adapted based on available computational resources. For example, with a limited-compute resource, foreground detection 406 can use a binary approach where regions either use standard or heightened sensitivity based on a presence of important object classes in bounding box detection 404. For another example, with a high-compute resource, foreground detection 406 can create and/or update separate sets of Gaussian distributions, with mean, variance, and/or importance values, for each detected object class to optimize foreground detection based on motion patterns typical of each object type (e.g., for a person object class, distributions modeling common walking poses have higher importance values and larger variances, while for a tree object class, distributions modeling slight movement have lower importance values and smaller variances).

In some embodiments, foreground detection 406 applies post-processing techniques to refine a foreground-background separation mask. In some embodiments, morphological techniques remove noise and/or fill incomplete or disconnected regions in the foreground-background separation mask. For example, with a high-compute resource, foreground detection 406 can apply a sequence of operations (e.g., erosion followed by dilation, and/or opening followed by closing) with varying processing windows (e.g., 3×3 pixels or 7×7 pixels) based on detected object size. For another example, with a limited-compute resource, foreground detection 406 can apply basic morphological operations with fixed processing windows to reduce computational complexity.

In some embodiments, output of process 400 is combined differently based on deployment scenarios. For example, in high-compute and/or high-security monitoring scenario requiring precise object tracking, output (e.g., 402, 404, and/or 406) is used with multi-scale processing and/or instance-aware parameter adjustment. For another example, in a basic motion alerting and/or low-compute scenario, bounding box detection 404 can be used at reduced capacity (e.g., single-scale and/or limited object classes) while foreground detection 406 can use fixed thresholds instead of instance-aware parameter adjustment.

FIG. 5 illustrates an exemplary process for performing resource-adaptive motion detection in accordance with some embodiments. The process in this figure is used to illustrate different processes for detecting motion, including the processes in FIGS. 7-9.

In some embodiments, process 500 illustrates how motion detection techniques are dynamically adjusted based on an available computational resource on a device executing at least a portion of process 500, combining an audio-based detection model trained using process 300 described above with respect to FIG. 3 with different levels of visual detection techniques described above with respect to FIG. 4.

As illustrated in FIG. 5, process 500 includes compute check 502 that determines an available computational resource of a device executing at least a portion of process 500, such a device with a camera and a microphone, and directs processing through either a limited compute path 504 or a higher compute path 506. In some embodiments, compute check 502 evaluates capabilities of the device, such as available memory, presence of GPU, and/or processing power to determine which motion detection techniques can be supported. For example, compute check 502 can query and/or identify system specifications to determine if available system memory is below a threshold (e.g., less than 8 gigabytes of Random Access Memory (RAM) indicating limited compute) or above the threshold (e.g., 8 or more gigabytes of RAM indicating higher compute). In some embodiments, compute check 502 is performed when at least a portion of process 500 is first deployed on the device. In some embodiments, compute check 502 is performed each time at least a portion of process 500 is initialized to account for ongoing system loads of the device.

In some embodiments, when compute check 502 determines that only limited compute is available, process 500 includes only loading a model, pipeline, and/or system underlying limited compute path 504 on a device, since loading a model, pipeline, and/or system underlying higher compute path 506 would exceed available resources. In some embodiments, when compute check 502 determines that higher compute is available, process 500 includes either only loading the model, pipeline, and/or system underlying higher compute path 506 or loading both models, pipelines, and/or systems underlying higher compute path 506 and limited compute path 504. For example, loading both models, pipelines, and/or systems on a device with higher compute resources allows the device to switch to limited compute path 504 if available resources become constrained due to competing workloads and/or system conditions on the device.

In some embodiments, when compute check 502 determines limited compute is available, process 500 includes proceeding with limited compute path 504, which uses lightweight detection techniques that can operate within resource constraints of the device. In some embodiments, limited compute path 504 starts with receiving (504a) a video frame with corresponding audio bytes.

In some embodiments, after receiving the video frame with the corresponding audio bytes for limited compute path 504, process 500 includes extracting consecutive video frames and corresponding audio segments (e.g., at lower resolution and/or sampling rates) as described above with respect to consecutive frames 304 and audio of consecutive frames 306 in FIG. 3. In some embodiments, limited compute path 504 maintains temporal alignment between video and audio data using techniques described above with respect to FIG. 3, such as with processing optimizations for limited compute. For example, while maintaining video frame rates (e.g., 29.97 or 60 frames per second) and corresponding audio segment durations (e.g., 33.67 or 16.67 milliseconds), video frames can be processed for limited compute path 504 at a reduced pixel resolution (e.g., down sampling from 1920×1080 pixels to 640×480 pixels) to decrease memory requirements. For another example, audio can be extracted for limited compute path 504 at a lower sampling rate (e.g., 22.05 kHz instead of 44.1 kHz) and synchronized with video frames using timestamp metadata and/or frame indices at these reduced rates. In some embodiments, minimal preprocessing of video frames (e.g., single pass RGB to grayscale conversion rather than multi-step color space transformations) and audio bytes (e.g., fixed-threshold amplitude scaling rather than adaptive normalization) is performed for limited compute path 504 to reduce computational overhead while maintaining data quality sufficient for subsequent motion detection steps.

In some embodiments, video frames and corresponding audio segments are extracted and output for limited compute path 504 using frame rates, resolutions, and/or audio sampling formats described above with respect to consecutive frames 304 and audio of consecutive frames 306 in FIG. 3 (e.g., maintaining video frame rates and/or temporal alignment between video and audio). In some embodiments, output of video frames and audio segments uses simplified representations that are optimized for limited compute. For example, while process 300 described above with respect to FIG. 3 processes video frames in full RGB or YUV color spaces and/or with normalized pixel values (e.g., in a range of 0-1) for training a vision-based detection model, frames can be stored for limited compute path 504 as single-channel grayscale pixel data to reduce memory requirements from three color channels to one color channel (e.g., resulting in a 66% reduction in memory usage). For another example, while FIG. 3 processes audio using feature extraction techniques such as MFCC computation with 13 or more coefficients per audio segment to train audio-based motion detection model 314, audio can be stored for limited compute path 504 as raw waveform amplitudes over time (e.g., sequences of 16-bit integers representing audio amplitude at each sampling point). In some embodiments, storing raw waveform amplitudes avoids computationally expensive Fourier transforms and/or Mel-scale conversions needed for frequency analysis, while still capturing essential motion-related sound patterns.

In some embodiments, after receiving the video frame with the corresponding audio bytes and/or processing such as described above, limited compute path 504 proceeds to performing a combination of a lightweight visual motion detection (504c) with a first audio motion detection (504d). In some embodiments, unlike the instance segmentation process described above with respect to FIG. 4 that requires higher computational resources to classify and/or track thousands of object classes, the lightweight visual detection focuses on detecting motion using simplified techniques. For example, the lightweight visual motion detection can first employ Gaussian Mixture Models (GMM) for foreground-background separation, followed by frame differencing on foreground regions to detect motion between consecutive frames, as a computationally efficient alternative to instance segmentation.

In some embodiments, the lightweight visual detection processes each pixel through multiple stages to detect motion. For example, the lightweight visual detection can include a GMM-based detection to distinguish foreground elements from background elements by maintaining statistical models of background pixel appearances and/or implementing a limited compute approach described above with respect to foreground detection 406 in FIG. 4. For example, as described in foreground detection 406 for limited compute scenarios, the lightweight visual detection can use a single Gaussian distribution per pixel with fixed parameters rather than multiple distributions with instance-aware adjustments. For another example, when a pixel shows variation in appearance due to lighting and/or shadow changes, the lightweight visual detection can use a single statistical model to classify a pixel as background or foreground, rather than maintaining separate distributions for different lighting conditions.

In some embodiments, the lightweight visual detection implements a Gaussian model through any combination of three processing stages to identify foreground regions before applying frame differencing. In such embodiments, a first stage can initialize a Gaussian distribution for each pixel with mean and variance parameters representing expected background appearance. In such embodiments, a second stage can classify a pixel value as foreground or background based on a deviation of the pixel from a modeled background distribution. For example, if a pixel's current value differs from a background mean by more than 2.5 standard deviations, it is classified as foreground, indicating potential motion.

In such embodiments, a third stage can update background model parameters using a fixed learning rate (e.g., 0.01 for pixels classified as background) to allow adaptation to gradual lighting changes while maintaining sensitivity to sudden motion-related changes. In some embodiments, the lightweight visual detection applies basic spatial filtering using fixed-size processing windows, similar to a limited-compute technique described above with respect to foreground detection 406 in FIG. 4, to remove isolated foreground pixels and/or fill gaps in detected foreground regions. After identifying foreground regions, the lightweight visual detection can apply frame differencing by computing absolute pixel-value differences between consecutive frames within these foreground regions to detect motion. For example, when changes are gradual, such as lighting transitions throughout a day and/or shadows moving across a scene, the fixed learning rate allows the background model mean and variance to slowly adapt since each new observation differs only slightly from the background model. For another example, when an object moves through a scene, pixel values differ significantly from a mean and variance of the background model. In some embodiments, large deviations (e.g., pixel values that differ by more than 2.5 or 3.0 standard deviations from the background model mean) cause immediate classification as foreground motion since the fixed learning rate is too slow to immediately incorporate such significant changes into the background model. For another example, in regions identified as foreground, frame differencing computes absolute differences between consecutive frames to identify motion patterns (e.g., subtracting pixel values in a second frame from corresponding pixel values in a first frame to measure changes in intensity and/or luminosity). In such an example, motion can be detected when frame differencing in these foreground regions detects large pixel value changes between frames, while the background model's fixed learning rate can ensure that these substantial changes are not incorrectly incorporated into the background model. For another example, frame differencing computes differences in pixel intensity between frames, where intensity represents raw brightness of a pixel calculated as a sum of its red, green, and blue (RGB) values. For example, a pixel in a first frame with RGB values (200, 150, and 100) has an intensity of 450, and if the same pixel in a second frame has RGB values (180, 130, and 80) with intensity 390, frame differencing would detect an intensity difference of 60 units, which could indicate motion based on a defined threshold.

In some embodiments, performing the first audio motion detection uses audio-based motion detection model 314 as described above with respect to FIG. 3. In some embodiments, audio-based motion detection model 314 is optimized for limited compute. For example, while process 300 uses audio processing techniques (e.g., MFCC computation, spectral feature extraction, and/or wavelet transforms as described in FIG. 3) to generate numerical vectors representing audio characteristics, the first audio motion detection can operate on raw waveform amplitudes (e.g., sequences of 16 bit or 24 bit integer values representing audio pressure levels at each sampling point, where each sampling point corresponds to a specific time in the audio signal, or normalized floating-point values between −1.0 and 1.0 representing relative amplitude at each time interval) to detect motion-related sound patterns. In such an example, at a sampling rate of 22.05 kHz and 16 bit integer representation, the first audio motion detection can process 22,050 amplitude values per second, with each value ranging from- 32,768 to 32,767 representing sound pressure levels. For another example, using normalized floating-point representation, amplitude values can be scaled between −1.0 and 1.0, where values closer to 0 represent ambient noise levels and values closer to 1.0 represent peak sound levels in an audio segment. In some embodiments, the first audio motion detection analyzes audio segments corresponding to consecutive frames to identify sound patterns indicative of motion, such as significant deviations in amplitude from baseline background levels (e.g., amplitude spike 2 times above ambient noise floor), periodic amplitude modulations (e.g., consistent motion patterns such as footsteps, walking gaits, and/or running impacts), and/or amplitude envelope transitions (e.g., transitional sounds such as door opening or closing, vehicle starting or stopping, and/or gate latching or unlatching).

In some embodiments, performing the first audio motion detection results in outputting a confidence score between 0 and 1 that indicate likelihood of motion detected. In some embodiments, this confidence score is combined with output from the lightweight visual detection using a dynamic weighting approach to generate a final motion detection output. In such embodiments, a relative contribution of visual and audio detection can be determined based on signal strength from the different detections. For example, in scenarios with minimal audio significance (e.g., distant motion and/or quiet environment), a higher weight can be assigned to visual motion detection (e.g., 0.95 or 0.90) and a lower weight can be assigned to audio motion detection (e.g., 0.05 or 0.1). For another example, when visual detection is ambiguous (e.g., low contrast scenes or similar background-foreground values) but clear motion-related sounds are detected, a higher weight can be assigned to audio motion detection than visual motion detection. In some embodiments, weighting between audio and visual detection is continuously adjusted based on factors affecting signal quality in video and/or audio detection (e.g., environmental conditions such as weather and/or lighting changes, scene characteristics such as contrast levels and/or background complexity, signal-to-noise ratios in audio, and/or distance-based attenuation of visual and/or audio signals). For example, during rainfall and/or high wind conditions that generate significant background noise, an audio detection weight can be reduced to minimize false positives from environmental sounds. For another example, in low-light conditions where visual detection becomes less reliable, the audio detection weight can be increased to reduce reliance on the visual detection.

In some embodiments, when compute check 502 determines higher compute is available, process 500 proceeds with higher compute path 506, which uses additional available compute resources for higher confidence motion detection. In some embodiments, higher compute path 506 starts with receiving (506a) a video frame with corresponding audio bytes, similar to step 504a, without computational constraints on processing.

In some embodiments, after receiving the video frame with the corresponding audio bytes for higher compute path 506, process 500 includes extracting consecutive video frames and corresponding audio segments (e.g., at full resolution and/or sampling rates) as described above with respect to consecutive frames 304 and audio of consecutive frames 306 in FIG. 3. In some embodiments, higher compute path 506 maintains the same temporal alignment between video and audio data using techniques described above with respect to FIG. 3, such as with performing full-resolution preprocessing on extracted video frames and/or high-fidelity processing on audio segments. For example, while maintaining video frame rates (e.g., 29.97 or 60 frames per second), video frames can be processed for higher compute path 506 at their original resolution and/or preprocessing can be applied such as multi-scale color space conversions and/or noise reduction as described above with respect to FIG. 4. For another example, audio can be processed for higher computer path 506 at sampling rates sufficient to capture high-frequency motion sounds (e.g., 44.1 kHz or 48 kHz) and/or at bit depths that allow for precise amplitude measurement (e.g., 16 bit or 24 bit quantization levels) to maintain accuracy in detecting both subtle and significant motion-related audio changes.

In some embodiments, after receiving the video frame with the corresponding audio bytes and/or processing such as described above, higher compute path 506 proceeds to performing a combination (506b) of a heavyweight visual motion detection (506c) with a second audio motion detection (506d).

In some embodiments, performing the heavyweight visual motion detection uses a deep optical flow algorithm in conjunction with instance segmentation that was described above with respect to FIG. 4. In such embodiments, for each pair of consecutive frames, the heavyweight visual motion detection first employs a deep optical flow algorithm to analyze pixel-level displacements between frames, then uses instance segmentation to classify regions with significant pixel displacement based on object type. In some embodiments, the deep optical flow algorithm is implemented using a convolutional neural network (CNN) trained on large-scale motion datasets, where the network processes pairs of consecutive frames through multiple layers to compute pixel-wise displacement vectors. For example, if a person is walking from left to right between two frames, the deep optical flow algorithm generates horizontal motion vectors for pixels representing the person, where vector directions indicate rightward motion, while vector magnitudes increase with faster movement. For another example, as a car approaches a camera, the deep optical flow algorithm generates outward-radiating motion vectors that reflect the car's expansion between two frames, where vector directions point outward from a center of the car, and vector magnitudes increase with the car's proximity, showing faster pixel displacement as the car moves closer to the camera. In some embodiments, the deep optical flow algorithm identifies regions of motion by detecting direction and/or speed of pixel displacements between consecutive frames, while instance segmentation subsequently analyzes these regions of motion to determine their object classes. For example, when a person walks across a frame, the deep optical flow algorithm detects a cohesive region of pixel movement in a human-like shape, after which instance segmentation analyzes this cohesive region of pixel movement and classifies it as a “person” with a corresponding confidence score (e.g., 97%). For another example, when wind causes tree branches to move, the deep optical flow algorithm first detects multiple regions of oscillating pixel movement, after which instance segmentation analyzes these regions and classifies them as “tree” or “leaves”.

In some embodiments, performing the second audio motion detection uses audio-based motion detection model 314 as described above with respect to FIG. 3. In some embodiments, the second audio motion detection performs full feature extraction on audio segments, including MFCC computation, spectral analysis, and/or wavelet transforms as described above with respect to numerical vector of audio 310 in FIG. 3. In some embodiments, the second audio motion detection maintains temporal buffers of audio features to analyze motion patterns over longer time periods compared to the first audio motion detection (e.g., as described above with respect to 504d). For example, the second audio motion detection can maintain a sliding window of multiple seconds of audio features to detect sustained motion patterns and/or track multiple moving sound sources.

In some embodiments, performing the second audio motion detection results in outputting a confidence score between 0 and 1 that indicate likelihood of motion detected. In some embodiments, this confidence score is combined with output from the heavyweight visual detection using a dynamic weighting approach to generate a final motion detection output. In such embodiments, a relative contribution of visual and audio detection can be determined based on signal characteristics, detected object types, and/or audio-visual correlation patterns. For example, in a scenario with minimal audio significance (e.g., when performing the second audio motion detection and no clear motion-related sounds are detected), a higher weight can be assigned to the heavyweight visual detection and a lower weight to the second audio motion detection. For another example, in low-light conditions where performing the heavyweight visual detection has reduced confidence in motion analysis and/or object classification while performing the second audio motion detection identifies clear motion-related audio patterns (e.g., distinct footstep sounds and/or car engine noise), a weight of audio detection can be increased relative to visual detection.

In some embodiments, the combination of audio and visual detection (e.g., lightweight visual detection and first audio motion detection and/or heavyweight visual detection and second audio detection) can be augmented with additional motion signals from other input modalities as described above with respect to data sources 302 in FIG. 3. For example, home automation system activity logs, ultrasonic sensors, PIR sensors, depth sensors, thermal sensors, and/or radar sensors can provide additional motion detection signals that can be combined with visual and audio detection using the dynamic weighting approach. For another example, current weather conditions can be used to adjust weighting of different motion detection signals, such as reducing weight of audio detection during high wind conditions and/or adjusting weight visual detection during rainfall. In some embodiments, audio-based motion detection model 314, which is used in both first audio motion detection and second audio motion detection, can be trained (e.g., such as during offline training) on visual and/or audio data from devices such as a camera, microphone and/or other sensors as described above, which are separate from the device executing at least a portion of process 500.

In some embodiments, the combination of audio and visual detection can selectively ignore motion based on object classification. For example, when heavyweight visual detection identifies objects of certain classifications (e.g., trees, curtains, and/or balloons), motion detected for these objects can be ignored while motion of other object classifications (e.g., people and/or vehicles) is detected and/or indicated. In some embodiments, audio motion detection similarly ignores sounds associated with certain object classifications (e.g., such as noise from objects identified as background elements) while maintaining audio signal from objects of interest (e.g., such as foreground elements) in motion detection. In some embodiments, this selective filtering of objects based on their classification can be implemented separately within each detection technique. For example, visual detection can independently filter out motion from certain objects (e.g., ignoring pixel displacement from swaying trees) and audio detection can independently filter out sounds from certain objects (e.g., ignoring wind noise through leaves).

In some embodiments, the combination of the heavyweight visual motion detection and the second audio motion detection outputs a motion detection result between 0 and 1 indicating likelihood of motion that is similar to the output of 504b described above. In some embodiments, the motion detection result is output with additional metadata. For example, the additional metadata can include object class labels with confidence scores, motion vectors from the deep optical flow algorithm, and/or audio characteristics that can be used by downstream systems. For another example, the additional metadata can include object tracking identifiers, such as unique identifiers, that allow a downstream system to group related motion events (e.g., tracking a delivery person approaching, dropping off a package, and/or departing).

In some embodiments, process 500 includes mechanisms to adaptively adjust performance when computational resources become constrained during performance of higher compute path 506. In such embodiments, if available compute drops below a threshold needed for higher compute path 506, process 500 either switches to limited compute path 504 as described above or selectively disables detection techniques (e.g., the deep optical flow algorithm, instance segmentation, and/or the second audio motion detection) while maintaining other motion detection techniques. For example, instance segmentation can be disabled while maintaining the deep optical flow algorithm and the second audio motion detection if GPU memory becomes limited. For another example, processing resolution can be reduced (e.g., from 1920×1080 pixels to 640×480 pixels) and/or frame rate can be reduced (e.g., from 60 frames per second to 30 frames per second) while maintaining all detection techniques at lower fidelity. In some embodiments, this adaptive resource management allows process 500 to maintain reliable motion detection even when compute resources fluctuate due to competing workloads and/or system conditions on the device executing at least a portion of process 500.

After detecting motion using limited compute path 504 and/or higher compute path 506, another computer system can be notified of the motion. For example, cameras and/or microphones capturing media used to detect the motion can be included in a home accessory ecosystem. In such an example, a controller and/or owner corresponding to the home accessory ecosystem can notified when the motion is detected. The notification can include video and/or audio that was used to detect the motion and/or a snapshot or image from the video. The notification can also include an identification of a time, a location, a textual representation of what the motion is determined to be, and/or other information corresponding the motion that was detected.

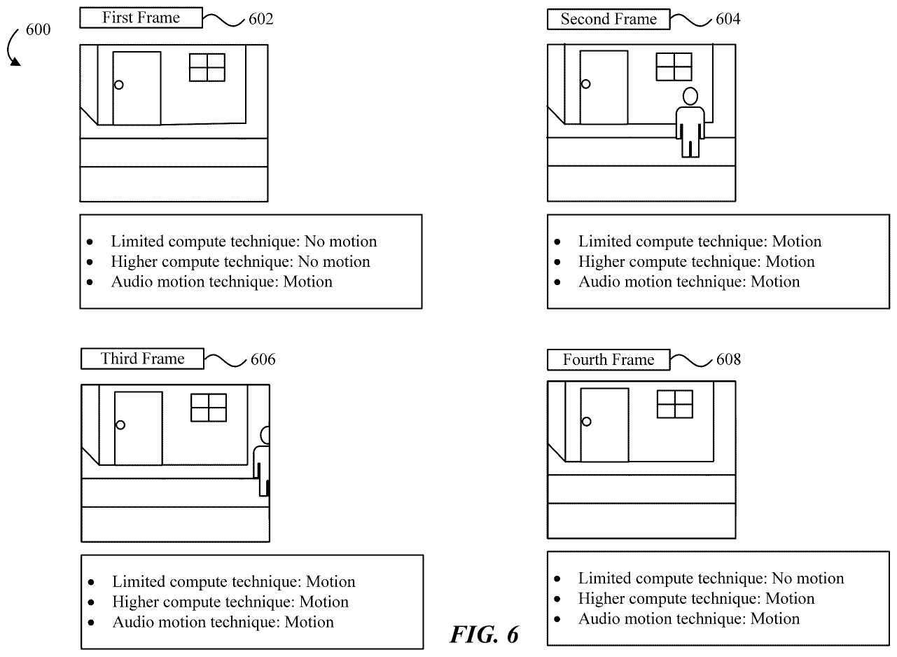

FIG. 6 illustrates an exemplary process for comparing motion detection techniques in accordance with some embodiments. Process 600 demonstrates relative performance between audio-based motion detection model 314 (e.g., illustrated with “Audio motion technique” in FIG. 6) as described above with respect to FIG. 3, limited compute path 504 (e.g., illustrated with “Limited compute technique” in FIG. 6) as described above with respect to FIG. 5, and higher compute path 506 (e.g., illustrated with “Higher compute technique” in FIG. 6) as described above with respect to FIG. 5. In some embodiments, audio-based motion detection model 314 as used with respect to FIG. 6 is trained to recognize audio that occurs before visual motion is detected while audio detection models of limited compute path 504 and higher compute path 506 as used with respect to FIG. 6 are not trained to recognized audio that occurs before visual motion is detected. For example, training audio-based motion detection model 314 can include identifying motion and modifying labels of one or more audio frames before the motion as indicative of pre-motion. In such an example, a number of labels of the one or more audio frames that are modified can be predefined and/or based on when such audio frames have audio that is determined to be statistically different from earlier audio.

In some embodiments, first frame 602 is evaluated as part of process 600, where motion occurs outside a field of view of a camera but within audio detection range. In some embodiments, in this first scenario, audio-based motion detection model 314 successfully detects motion via audio data while both limited compute path 504 and higher compute path 506 fail to detect motion due to lack of visual input, lack of audio-based motion detection weighting, and/or lack of being trained to recognize audio that occurs before visual motion is detected. For example, when a person walks closer to a home, audio-based motion detection model 314 can detect motion through detection of footstep sounds, as described above with respect to FIG. 5, even though the person never appears in the field of view of the camera.

In some embodiments, second frame 604 (e.g., a frame after first frame 602) is evaluated as part of process 600, where the person enters the field of view of the camera, creating detectable motion between first frame 602 and second frame 604. In some embodiments, in this second scenario, all three detection techniques detect motion. For example, audio-based motion detection model 314 continues detecting motion through detection of footstep sounds while limited compute path 504 detects significant pixel displacement through GMM-based foreground detection and/or frame differencing between frames 602 and 604 and higher compute path 506 detects horizontal motion vectors for pixels representing the person through a deep optical flow algorithm and classifies the moving region as a “person” through instance segmentation between frames 602 and 604 as described above with respect to FIG. 5.

In some embodiments, third frame 606 (e.g., a frame after second frame 604) is evaluated as part of process 600, where the person is partially visible at the edge of third frame 606. In some embodiments, in this third scenario, all three detection techniques continue to detect motion. For example, as the person begins exiting the frame, limited compute path 504 detects sufficient pixel displacement between frames 604 and 606 through GMM-based foreground detection and/or frame differencing between the two frames, the deep optical flow algorithm in higher compute path 506 generates pixel-wise displacement vectors showing movement of the person towards the frame edge, and audio-based motion detection model 314 continues detecting associated footstep sounds that indicate motion.

In some embodiments, fourth frame 608 (e.g., a frame after third frame 606) is evaluated as part of process 600, where the person has completely left the field of view of the camera but remains within audio detection range. In some embodiments, in this fourth scenario, limited compute path 504 fails to detect motion while both higher compute path 506 and audio-based motion detection model 314 succeed at detecting motion. For example, when comparing frames 606 and 608, the limited compute path's frame differencing does not identify sufficient pixel displacement between frames 604 and 606 while the deep optical flow algorithm in higher compute path 506 can still track partial motion patterns from the person's exit and audio-based motion detection model 314 maintains detection through audio signals received by the person's footsteps.

In the above examples of FIG. 6, after detecting motion, another computer system can be notified of the motion. For example, cameras and/or microphones capturing media used to detect the motion can be included in a home accessory ecosystem. In such an example, a controller and/or owner corresponding to the home accessory ecosystem can notified when the motion is detected. The notification can include video and/or audio that was used to detect the motion and/or a snapshot or image from the video. The notification can also include an identification of a time, a location, a textual representation of what the motion is determined to be, and/or other information corresponding the motion that was detected.

In some embodiments, process 600 illustrates advantages of combining audio-based motion detection model 314 with visual detection techniques in both limited compute path 504 and higher compute path 506. For example, while visual detection techniques can fail when motion occurs outside of a field of view of a camera (e.g., first frame 602) or when a moving object has slowly left the field of view (e.g., frames 606 and 608), audio-based motion detection model 314 can still detect motion through audio analysis. For another example, when both visual and audio signals are available, combining multiple detection techniques through dynamic weighting as described above with respect to FIG. 5 can enable more reliable motion detection by leveraging complementary strengths of each approach while allowing for computational efficiency.

FIG. 7 is a flow diagram illustrating a process (e.g., process 700) for detecting motion using optical flow and an audio model in accordance with some embodiments. Some operations in process 700 are, optionally, combined, the orders of some operations are, optionally, changed, and some operations are, optionally, omitted.

As described below, process 700 provides an intuitive way for detecting motion using optical flow and an audio model. Process 700 reduces the cognitive burden on a user, thereby creating a more efficient human-machine interface. For battery-operated computing devices, enabling a user to interact with such devices faster and more efficiently conserves power and increases the time between battery charges.

In some embodiments, process 700 is performed at a computer system (e.g., a device, a watch, a phone, a tablet, a fitness tracking device, a processor, a head-mounted display (HMD) device, a communal device, a media device, a speaker, a television, an electronic device, and/or a personal computing device).

The computer system receives (702) one or more visual frames (e.g., 402 and/or 506a) (e.g., a video frame, an image frame, an image, a heat map, and/or a depth map). In some embodiments, the one or more visual frames are received as a set of one or more visual frames. In some embodiments, the one or more visual frames are received in sequence as each visual frame of the one or more visual frames is captured. In some embodiments, the one or more visual frames are captured by one or more cameras of (e.g., included in and/or in communication with) the computer system.

The computer system receives (704) one or more audio frames (e.g., 506a) (e.g., an audio recording, an audio file, an audio record, an audio sample) corresponding to the one or more visual frames. In some embodiments, a frame includes an audio frame of the one or more audio frames and a visual frame of the one or more visual frames. In some embodiments, the one or more audio frames are received as a set of one or more audio frames. In some embodiments, the one or more audio frames are received in sequence as each audio frame of the one or more audio frames is captured. In some embodiments, the one or more audio frames are captured by one or more microphones of (e.g., included in and/or in communication with) the computer system. In some embodiments, a visual frame of the one or more visual frames is captured while an audio frame of the one or more audio frames is captured. In some embodiments, a number of audio frames in the one or more audio frames is the same number of frames as a number of visual frames in the one or more visual frames. In some embodiments, a number of audio frames in the one or more audio frames is a different number of frames as a number of visual frames in the one or more visual frames (e.g., multiple audio frames corresponds to a single visual frame or multiple visual frames corresponds to a single audio frame). In some embodiments, the one or more audio frames are received before, while, or after the one or more visual frames are received.

After (706) receiving the one or more visual frames and the one or more audio frames (e.g., as described with respect to 506) (and/or in response to receiving a visual frame of the one or more visual frames or an audio frame of the one or more audio frames), the computer system identifies (708) (and/or determines), based on an optical flow (e.g., as described with respect to 506c) (e.g., optic flow, pattern of apparent motion of one or more objects, surfaces, and/or edges, distribution of apparent velocities of movement of brightness pattern, instantaneous image velocity, and/or discrete image displacement) in the one or more visual frames, a first motion indication (e.g., result of 506c). In some embodiments, the optical flow is performed using phase correlation (e.g., inverse of normalized cross-power spectrum), a block-based method (e.g., minimizing sum of squared differences or sum of absolute differences, or maximizing normalized cross-correlation), a differential method (e.g., based on derivatives of an image signal and/or a sought flow field and higher-order partial derivatives, such as Lucas-Kanade method, Horn-Schunck method, Buxton-Buxton method, Black-Jepson method, and/or general variational method), and/or a discrete optimization method (e.g., a search space is quantized and image matching is addressed through label assignment at each pixel).

After (706) receiving the one or more visual frames and the one or more audio frames, the computer system identifies (710) (and/or determines), based on the one or more audio frames without being based on the one or more visual frames, a second motion indication (e.g., result of 506d) separate from the first motion indication. In some embodiments, the second motion indication is identified using a model (e.g., 314), such as a machine learning algorithm trained on labeled data sets (e.g., 312) of audio and visual frames.

After (712) (and/or in conjunction with) identifying the first motion indication and the second motion indication (and/or in response to identifying the first motion indication or the second motion indication), in accordance with a determination that a first set of one or more criteria is satisfied (e.g., that there is significant motion in an environment and/or that there is significant motion in the one or more visual frames and/or in the one or more audio frames) (e.g., combination of the first motion indication and the second motion indication as described with respect to 506), wherein the first set of one or more criteria includes a criterion that is satisfied based on the first motion indication and the second motion indication, the computer system outputs (714) (e.g., sends, displays, produces haptic output as, and/or outputs audio as) a first indication (e.g., result of combination of the first motion indication and the second motion indication as described above with respect to 506 and/or as described above with respect to notifying another computer system in regards to FIGS. 5-6) that motion has been detected. In some embodiments, the first set of one or more criteria includes a criterion that is satisfied based on a model (e.g., model used combine result of 506c and 506d), such as a machine learning algorithm that is based on the first motion indication and the second motion indication (e.g., weights each indication a different amount in different circumstances). In some embodiments, the first motion indication and/or the second motion indication are identified as part of the determination that the first set of one or more criteria is satisfied.

After (712) identifying the first motion indication and the second motion indication, in accordance with a determination that a second set of one or more criteria is satisfied (e.g., that there is no motion or insignificant motion in the environment and/or that there is insignificant motion in the one or more visual frames and/or in the one or more audio frames) (e.g., combination of the first motion indication and the second motion indication as described with respect to 506), wherein the second set of one or more criteria includes a criterion that is satisfied based on the first motion indication and the second motion indication, the computer system forgoes (716) output of an indication that motion has been detected (and/or outputs an indication that motion has not been detected), wherein the second set of one or more criteria is different from the first set of one or more criteria. In some embodiments, the second set of one or more criteria includes a criterion that is satisfied based on a model (e.g., model used in 506 to combine), such as a machine learning algorithm that is based on the first motion indication and the second motion indication (e.g., weights each indication a different amount in different circumstances). In some embodiments, the first motion indication and/or the second motion indication are identified as part of the determination that the second set of one or more criteria is satisfied.

In some embodiments, the one or more visual frames includes multiple, separate visual frames (e.g., as described with respect to 506a) (e.g., 2 or more visual frames, 3 or more visual frames, and/or 4 or more visual frames).

In some embodiments, the one or more audio frames includes multiple, separate audio frames (e.g., as described with respect to 506a) (e.g., 2 or more audio frames, 3 or more audio frames, and/or 4 or more audio frames).

In some embodiments, in conjunction with (e.g., together with, before, while, or after) outputting the first indication that motion has been detected, the computer system outputs a set of one or more visual frames (e.g., as described above with respect to notifying another computer system in regards to FIGS. 5-6) (e.g., with or without outputting a set of one or more audio frames). In some embodiments, the one or more visual frames includes the set of one or more visual frames. In some embodiments, the set of one or more visual frames includes the one or more visual frames. In some embodiments, the set of one or more visual frames includes at least one visual frame not included in the one or more visual frames. In some embodiments, the set of one or more visual frames does not includes the one or more visual frames. In some embodiments, the set of one or more visual frames is the one or more visual frames. In some embodiments, the one or more audio frames includes the set of one or more audio frames. In some embodiments, the set of one or more audio frames includes the one or more audio frames. In some embodiments, the set of one or more audio frames includes at least one audio frame not included in the one or more audio frames. In some embodiments, the set of one or more audio frames does not includes the one or more audio frames. In some embodiments, the set of one or more audio frames is the one or more audio frames.

In some embodiments, the first set of one or more criteria (and/or the second set of one or more criteria) includes a criterion that is based on a classification (e.g., a categorization, an identification, a class, and/or a type) of an object detected within the one or more visual frames (e.g., as described with respect to FIGS. 4-6).

In some embodiments, the first set of one or more criteria (and/or the second set of one or more criteria) ignores motion of a first type of object (e.g., as described with respect to FIGS. 4-5) (e.g., weather, an inanimate object, an object greater than a predefined size, and/or an object smaller than a predefined size). In some embodiments, the first set of one or more criteria (and/or the second set of one or more criteria) does not ignore motion of a second type of object (e.g., a person, an electronic device, a mechanical device, a living being, an animal, an object greater than a predefined size, and/or an object smaller than a predefined size) different from the first type of object. In some embodiments, the first set of one or more criteria includes a criteria that ignores motion of the first type of object.

In some embodiments, the first set of one or more criteria (and/or the second set of one or more criteria) ignores audio corresponding to the first type of object (e.g., as described with respect to FIGS. 4-5). In some embodiments, the first set of one or more criteria (and/or the second set of one or more criteria) does not ignore audio corresponding to the second type of object. In some embodiments, the first set of one or more criteria (and/or the second set of one or more criteria) does not ignore audio corresponding to the first type of object. In some embodiments, the first set of one or more criteria (and/or the second set of one or more criteria) ignores audio corresponding to the second type of object. In some embodiments, the first set of one or more criteria (and/or the second set of one or more criteria) ignores audio corresponding to a third type of object different from the first type of object and the second type of object. In some embodiments, the first set of one or more criteria (and/or the second set of one or more criteria) does not ignore audio corresponding to a fourth type of object different from the first type of object, the second type of object, and/or the third type of object. In some embodiments, the first set of one or more criteria includes a criteria that ignores audio corresponding to the first type of object.

In some embodiments, the computer system receives, from an accessory device (e.g., a device configured to be controlled by one or more other computer systems, such as the computer system), an indication of a current status of the accessory device (e.g., as described with respect to FIGS. 3 and 5). In some embodiments, the accessory is a display, a television, a light, a lock, a security system, a speaker, an appliance, a motion detector, and/or a thermostat. In some embodiments, the indication of the current status of the accessory device represents a change in a status of the accessory device. In some embodiments, the accessory device is not a camera or a microphone. In some embodiments, after receiving the indication of the current status of the accessory device, the computer system identifies, based on the indication of the current status of the accessory device, a third motion indication (e.g., motion indication as described with respect to FIGS. 3 and 5) separate from the first motion indication and the second motion indication. In some embodiments, the third motion indication is based on a change in a status of the accessory device. In some embodiments, after (and/or in conjunction with) identifying the first motion indication, the second motion indication, and the third motion indication (and/or in response to identifying the first motion indication, the second motion indication, or the third motion indication) and in accordance with a determination that a third set of one or more criteria is satisfied (e.g., that there is significant motion in an environment and/or that there is significant motion in the one or more visual frames, in the one or more audio frames, and/or based on the current status of the accessory device), wherein the third set of one or more criteria includes a criterion that is satisfied based on the third motion indication (and/or the first motion indication and/or the second motion indication), the computer system outputs (e.g., sends, displays, produces haptic output as, and/or outputs audio as) a second indication (e.g., the first indication or another indication different from the first indication) that motion has been detected (e.g., result of combination of the first motion indication and the second motion indication as described above with respect to 506 and/or as described above with respect to notifying another computer system in regards to FIGS. 5-6). In some embodiments, the third set of one or more criteria includes a criterion that is satisfied based on a model, such as a machine learning algorithm that is based on the first motion indication, the second motion indication, and/or the third motion indication (e.g., weights each indication a different amount in different circumstances). In some embodiments, the first motion indication, the second motion indication, and/or the third motion indication are identified as part of the determination that the third set of one or more criteria is satisfied. In some embodiments, the first set of one or more criteria (and/or the second set of one or more criteria) includes a criterion that is satisfied based on the current status (e.g., on, off, locked, unlocked, motion detected) of the accessory device. In some embodiments, the first set of one or more criteria (and/or the second set of one or more criteria) includes a criterion that is satisfied based on a change in the current status (e.g., on, off, locked, unlocked, motion detected) of the accessory device. In some embodiments, the third set of one or more criteria is the first set of one or more criteria.

In some embodiments, the computer system receives (e.g., from a server and/or another computer system separate from the computer system) an indication of a current weather state (e.g., as described with respect to FIGS. 3 and 5). In some embodiments, the indication of the current weather state is obtained by the computer system, such as in response to detecting motion via the first motion indication and/or the second motion indication. In some embodiments, the indication of the current weather state is sent by the server and/or the other computer system without the computer system requesting the current weather state. In some embodiments, after receiving the indication of the current weather state, the computer system identifies, based on the indication of the current weather state, a fourth motion indication separate from the first motion indication and the second motion indication (e.g., as described with respect to FIGS. 3 and 5). In some embodiments, after (and/or in conjunction with) identifying the first motion indication, the second motion indication, and the fourth motion indication (and/or in response to identifying the first motion indication, the second motion indication, or the fourth motion indication) and in accordance with a determination that a fourth set of one or more criteria is satisfied (e.g., that there is significant motion in an environment and/or that there is significant motion in the one or more visual frames, in the one or more audio frames, and/or based on the current weather state), wherein the fourth set of one or more criteria includes a criterion that is satisfied based on the fourth motion indication (and/or the first motion indication and/or the second motion indication), the computer system outputs (e.g., sends, displays, produces haptic output as, and/or outputs audio as) a third indication (e.g., the first indication or another indication different from the first indication) that motion has been detected (e.g., result of combination of the first motion indication and the second motion indication as described above with respect to 506 and/or as described above with respect to notifying another computer system in regards to FIGS. 5-6). In some embodiments, the fourth set of one or more criteria includes a criterion that is satisfied based on a model, such as a machine learning algorithm that is based on the first motion indication, the second motion indication, and/or the fourth motion indication (e.g., weights each indication a different amount in different circumstances). In some embodiments, the first motion indication, the second motion indication, and/or the fourth motion indication are identified as part of the determination that the fourth set of one or more criteria is satisfied. In some embodiments, the first set of one or more criteria (and/or the second set of one or more criteria) includes a criterion that is satisfied based on the current weather state. In some embodiments, the first set of one or more criteria (and/or the second set of one or more criteria) includes a criterion that is satisfied based on a change in the current weather state. In some embodiments, the fourth set of one or more criteria is the first set of one or more criteria.

In some embodiments, after (and/or in conjunction with) identifying the first motion indication and the second motion indication (and/or in response to identifying the first motion indication or the second motion indication), in accordance with a determination that a fifth set of one or more criteria is satisfied (e.g., that there is significant motion in an environment and/or that there is significant motion in the one or more visual frames and/or in the one or more audio frames), wherein the fifth set of one or more criteria includes a criterion that is satisfied when the first motion indication is below a threshold (e.g., that the one or more visual frames are indicative of less motion than the threshold), wherein the fifth set of one or more criteria includes a criterion that is satisfied based on the second motion indication more than the first motion indication, the computer system outputs (e.g., sends, displays, produces haptic output as, and/or outputs audio as) a fourth indication that motion has been detected (e.g., result of combination of the first motion indication and the second motion indication as described above with respect to 506 and/or as described above with respect to notifying another computer system in regards to FIGS. 5-6). In some embodiments, the fifth set of one or more criteria includes a criterion that is satisfied based on a model, such as a machine learning algorithm that is based on the first motion indication and the second motion indication (e.g., weights each indication a different amount in different circumstances). In some embodiments, the first motion indication and/or the second motion indication are identified as part of the determination that the fifth set of one or more criteria is satisfied. In some embodiments, the fifth set of one or more criteria is the first set of one or more criteria. In some embodiments, after identifying the first motion indication and the second motion indication, in accordance with a determination that a sixth set of one or more criteria is satisfied (e.g., that there is significant motion in an environment and/or that there is significant motion in the one or more visual frames and/or in the one or more audio frames), wherein the sixth set of one or more criteria includes a criterion that is satisfied when the first motion indication is above the threshold, wherein the sixth set of one or more criteria includes a criterion that is satisfied based on the first motion indication more than the second motion indication, the computer system outputs (e.g., sends, displays, produces haptic output as, and/or outputs audio as) a fifth indication (e.g. the fourth indication or another indication different from the fourth indication) (e.g., result of combination of the first motion indication and the second motion indication as described above with respect to 506 and/or as described above with respect to notifying another computer system in regards to FIGS. 5-6) that motion has been detected, wherein the sixth set of one or more criteria is different from the fifth set of one or more criteria. In some embodiments, the sixth set of one or more criteria includes a criterion that is satisfied based on a model, such as a machine learning algorithm that is based on the first motion indication and the second motion indication (e.g., weights each indication a different amount in different circumstances). In some embodiments, the first motion indication and/or the second motion indication are identified as part of the determination that the sixth set of one or more criteria is satisfied.

In some embodiments, after (and/or in conjunction with) identifying the first motion indication and the second motion indication (and/or in response to identifying the first motion indication or the second motion indication) and in accordance with a determination that a seventh set of one or more criteria is satisfied (e.g., that there is significant motion in an environment and/or that there is significant motion in the one or more visual frames and/or in the one or more audio frames), wherein the seventh set of one or more criteria includes a criterion that is satisfied when the first motion indication is below a threshold (e.g., that the one or more visual frames are indicative of less motion than the threshold), wherein the seventh set of one or more criteria is satisfied based on the second motion indication without being based on the first motion indication, the computer system outputs (e.g., sends, displays, produces haptic output as, and/or outputs audio as) a sixth indication that motion has been detected (e.g., result of combination of the first motion indication and the second motion indication as described above with respect to 506 and/or as described above with respect to notifying another computer system in regards to FIGS. 5-6). In some embodiments, the seventh set of one or more criteria includes a criterion that is satisfied based on a model, such as a machine learning algorithm that is based on the first motion indication and/or the second motion indication (e.g., weights each indication a different amount in different circumstances). In some embodiments, the first motion indication and/or the second motion indication are identified as part of the determination that the seventh set of one or more criteria is satisfied.

In some embodiments, the one or more visual frames are one or more first visual frames. In some embodiments, after receiving the one or more first visual frames, the computer system receives, one or more second visual frames (e.g., 402 and/or 504a) (e.g., a video frame, an image frame, an image, a heat map, and/or a depth map) separate from the one or more first visual frames. In some embodiments, the one or more second visual frames are received as a set of one or more visual frames. In some embodiments, the one or more second visual frames are received in sequence as each visual frame of the one or more second visual frames is captured. In some embodiments, the one or more second visual frames are captured by one or more cameras of (e.g., included in and/or in communication with) the computer system. In some embodiments, after identifying the first motion indication, the computer system detects a bandwidth level (e.g., a compute level, a network level, and/or a memory level) (e.g., 502) of the computer system. In some embodiments, after detecting the bandwidth level of the computer system, in accordance with a determination that the bandwidth level of the computer system exceeds a threshold (e.g., that the bandwidth level of the computer system is enough to perform identification of an optical flow), the computer system identifies (and/or determines), based on an optical flow (e.g., optic flow, pattern of apparent motion of one or more objects, surfaces, and/or edges, distribution of apparent velocities of movement of brightness pattern, instantaneous image velocity, and/or discrete image displacement) (e.g., as described above with respect to FIGS. 3 and/or 506c) in the one or more second visual frames, a fifth motion indication (e.g., as described with respect to 506c5). In some embodiments, after detecting the bandwidth level of the computer system, in accordance with a determination that the bandwidth level of the computer system does not exceed the threshold (e.g., that the bandwidth level of the computer system is not enough to perform identification of an optical flow), the computer system identifies (and/or determines), based on frame differencing (e.g., as described above with respect to FIGS. 3 and/or 504c) of the one or more second visual frames (e.g., and not based on an optical flow in the one or more second visual frames), a sixth motion indication (e.g., as described with respect to 504c). In some embodiments, the frame differencing of the one or more second visual frames includes calculating a difference (e.g., in color, illumination, location of content, and/or intensity) between a first frame of the one or more second visual frames and a second frame, separate from the first frame, of the one or more second visual frames. In some embodiments, after (and/or in conjunction with and/or in response to) identifying the fifth motion indication, in accordance with a determination that an eighth set of one or more criteria is satisfied (e.g., that there is significant motion in an environment and/or that there is significant motion in the one or more second visual frames and/or in one or more audio frames) (e.g., combination of the first motion indication and the second motion indication as described with respect to 506), wherein the eighth set of one or more criteria includes a criterion that is satisfied based on the fifth motion indication (and/or a motion indication identified based on one or more audio frames), the computer system outputs (e.g., sends, displays, produces haptic output as, and/or outputs audio as) a seventh indication that motion has been detected (e.g., result of combination of the first motion indication and the second motion indication as described above with respect to 506 and/or as described above with respect to notifying another computer system in regards to FIGS. 5-6). In some embodiments, the eighth set of one or more criteria includes a criterion that is satisfied based on a model, such as a machine learning algorithm that is based on the fifth motion indication. In some embodiments, the fifth motion indication is identified as part of the determination that the eighth set of one or more criteria is satisfied. In some embodiments, after identifying the fifth motion indication, in accordance with a determination that a ninth set of one or more criteria is satisfied (e.g., that there is no motion or insignificant motion in the environment and/or that there is insignificant motion in the one or more second visual frames and/or in one or more audio frames), wherein the ninth set of one or more criteria includes a criterion that is satisfied based on the fifth motion indication (and/or a motion indication identified based on one or more audio frames), the computer system forgoes output of an indication that motion has been detected (and/or outputs an indication that motion has not been detected), wherein the ninth set of one or more criteria is different from the eighth set of one or more criteria. In some embodiments, the ninth set of one or more criteria includes a criterion that is satisfied based on a model, such as a machine learning algorithm that is based on the fifth motion indication. In some embodiments, the fifth motion indication is identified as part of the determination that the ninth set of one or more criteria is satisfied. In some embodiments, after (and/or in conjunction with and/or in response to) identifying the sixth motion indication, in accordance with a determination that an tenth set of one or more criteria is satisfied (e.g., that there is significant motion in an environment and/or that there is significant motion in the one or more second visual frames and/or in one or more audio frames), wherein the tenth set of one or more criteria includes a criterion that is satisfied based on the sixth motion indication (and/or a motion indication identified based on one or more audio frames), the computer system outputs (e.g., sends, displays, produces haptic output as, and/or outputs audio as) an eighth indication that motion has been detected (e.g., result of combination of the first motion indication and the second motion indication as described above with respect to 506 and/or as described above with respect to notifying another computer system in regards to FIGS. 5-6). In some embodiments, the tenth set of one or more criteria includes a criterion that is satisfied based on a model, such as a machine learning algorithm that is based on the sixth motion indication. In some embodiments, the sixth motion indication is identified as part of the determination that the tenth set of one or more criteria is satisfied. In some embodiments, after identifying the sixth motion indication, in accordance with a determination that an eleventh set of one or more criteria is satisfied (e.g., that there is no motion or insignificant motion in the environment and/or that there is insignificant motion in the one or more second visual frames and/or in one or more audio frames), wherein the eleventh set of one or more criteria includes a criterion that is satisfied based on the sixth motion indication (and/or a motion indication identified based on one or more audio frames), the computer system forgoes output of an indication that motion has been detected (and/or outputs an indication that motion has not been detected), wherein the eleventh set of one or more criteria is different from the tenth set of one or more criteria. In some embodiments, the eleventh set of one or more criteria includes a criterion that is satisfied based on a model, such as a machine learning algorithm that is based on the sixth motion indication. In some embodiments, the sixth motion indication is identified as part of the determination that the eleventh set of one or more criteria is satisfied.

In some embodiments, the computer system includes one or more cameras and one or more microphones. In some embodiments, the one or more visual frames are captured via the one or more cameras. In some embodiments, the one or more audio frames are captured via the one or more microphones (e.g., as described with respect to FIGS. 3 and/or 5).

In some embodiments, the second motion indication is identified using a model (e.g., 314) trained on data from one or more sensors not included in the computer system (e.g., as described with respect to FIG. 3).

In some embodiments, the second motion indication is identified using a model (e.g., 314) trained on data from one or more sensors included in the computer system (e.g., as described with respect to FIG. 3).

Note that details of the operations described above with respect to process 700 (e.g., FIG. 7) are also applicable in an analogous manner to other processes described herein. For example, process 800 optionally includes one or more of the characteristics of the various processes described above with reference to process 700. For example, the first motion indication of process 700 can be used as part of the determination that the first set of one or more criteria is satisfied of process 800. For brevity, these details are not repeated herein.

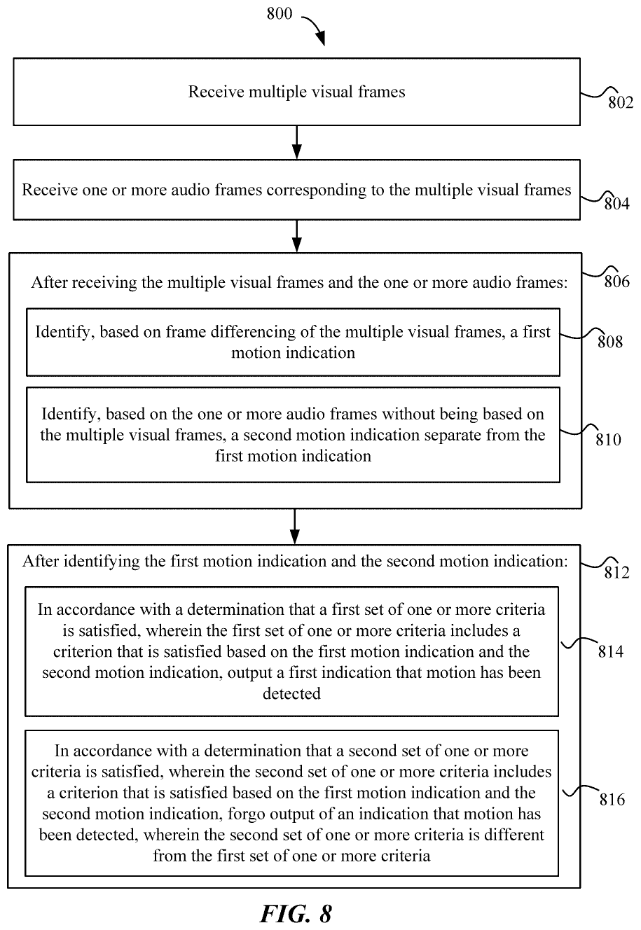

FIG. 8 is a flow diagram illustrating a process (e.g., process 800) for detecting motion using frame differencing and an audio model in accordance with some embodiments. Some operations in process 800 are, optionally, combined, the orders of some operations are, optionally, changed, and some operations are, optionally, omitted.

As described below, process 800 provides an intuitive way for detecting motion using frame differencing and an audio model. Process 800 reduces the cognitive burden on a user, thereby creating a more efficient human-machine interface. For battery-operated computing devices, enabling a user to interact with such devices faster and more efficiently conserves power and increases the time between battery charges.

In some embodiments, process 800 is performed at a computer system (e.g., a device, a watch, a phone, a tablet, a fitness tracking device, a processor, a head-mounted display (HMD) device, a communal device, a media device, a speaker, a television, an electronic device, and/or a personal computing device).

The computer system receives (802) multiple visual frames (e.g., 402 and/or 504a) (e.g., a video frame, an image frame, an image, a heat map, and/or a depth map). In some embodiments, the multiple visual frames are received as a set of multiple visual frames. In some embodiments, the multiple visual frames are received in sequence as each visual frame of the multiple visual frames is captured. In some embodiments, the multiple visual frames are captured by one or more cameras of (e.g., included in and/or in communication with) the computer system.

The computer system receives (804) one or more audio frames (e.g., 504a) (e.g., an audio recording, an audio file, an audio record, an audio sample) corresponding to the multiple visual frames. In some embodiments, a frame includes an audio frame of the one or more audio frames and a visual frame of the multiple visual frames. In some embodiments, the one or more audio frames are received as a set of one or more audio frames. In some embodiments, the one or more audio frames are received in sequence as each audio frame of the one or more audio frames is captured. In some embodiments, the one or more audio frames are captured by one or more microphones of (e.g., included in and/or in communication with) the computer system. In some embodiments, a visual frame of the multiple visual frames is captured while an audio frame of the one or more audio frames is captured. In some embodiments, a number of audio frames in the one or more audio frames is the same number of frames as a number of visual frames in the multiple visual frames. In some embodiments, a number of audio frames in the one or more audio frames is a different number of frames as a number of visual frames in the multiple visual frames (e.g., multiple audio frames corresponds to a single visual frame or multiple visual frames corresponds to a single audio frame). In some embodiments, the one or more audio frames are received before, while, or after the multiple visual frames are received.

After (806) receiving the multiple visual frames and the one or more audio frames (and/or in response to receiving a visual frame of the multiple visual frames or an audio frame of the one or more audio frames) (e.g., as described with respect to 504), the computer system identifies (808) (and/or determines), based on frame differencing (e.g., as described with respect to 504c) of the multiple visual frames, a first motion indication (e.g., result of 504c). In some embodiments, the frame differencing of the multiple visual frames includes calculating a difference (e.g., in color, illumination, location of content, and/or intensity) between a first frame of the multiple visual frames and a second frame, separate from the first frame, of the multiple visual frames.

After (806) receiving the multiple visual frames and the one or more audio frames, the computer system identifies (810) (and/or determines), based on the one or more audio frames without being based on the multiple visual frames, a second motion indication (e.g., result of 504d) separate from the first motion indication. In some embodiments, the second motion indication is identified using a model (e.g., 314), such as a machine learning algorithm trained on labeled data sets (e.g., 312) of audio and visual frames.

After (812) (and/or in conjunction with) identifying the first motion indication and the second motion indication (and/or in response to identifying the first motion indication or the second motion indication), in accordance with a determination that a first set of one or more criteria is satisfied (e.g., that there is significant motion in an environment and/or that there is significant motion in the one or more visual frames and/or in the one or more audio frames) (e.g., combination of the first motion indication and the second motion indication as described with respect to 504), wherein the first set of one or more criteria includes a criterion that is satisfied based on the first motion indication and the second motion indication, the computer system outputs (814) (e.g., sends, displays, produces haptic output as, and/or outputs audio as) a first indication that motion has been detected (e.g., result of combination of the first motion indication and the second motion indication as described above with respect to 506 and/or as described above with respect to notifying another computer system in regards to FIGS. 5-6). In some embodiments, the first set of one or more criteria includes a criterion that is satisfied based on a model, such as a machine learning algorithm that is based on the first motion indication and the second motion indication (e.g., weights each indication a different amount in different circumstances). In some embodiments, the first motion indication and/or the second motion indication are identified as part of the determination that the first set of one or more criteria is satisfied.

After (812) identifying the first motion indication and the second motion indication, in accordance with a determination that a second set of one or more criteria is satisfied (e.g., that there is no motion or insignificant motion in the environment and/or that there is insignificant motion in the one or more visual frames and/or in the one or more audio frames), wherein the second set of one or more criteria includes a criterion that is satisfied based on the first motion indication and the second motion indication, the computer system forgoes (816) output of an indication that motion has been detected (and/or outputs an indication that motion has not been detected), wherein the second set of one or more criteria is different from the first set of one or more criteria. In some embodiments, the second set of one or more criteria includes a criterion that is satisfied based on a model (e.g., model used in 504 to combine), such as a machine learning algorithm that is based on the first motion indication and the second motion indication (e.g., weights each indication a different amount in different circumstances). In some embodiments, the first motion indication and/or the second motion indication are identified as part of the determination that the second set of one or more criteria is satisfied.

In some embodiments, the frame differencing (1) is performed on a foreground (e.g., as described above with respect to 406) of the multiple visual frames (e.g., as described with respect to 504c) and (2) is not performed on a background of the multiple visual frames (e.g., as described with respect to 504c). In some embodiments, before identifying the first motion indication, the computer system divides each visual frame in the multiple visual frames into a foreground and a background. In such embodiments, the frame differencing is performed on the foreground and is not performed on the background. In some embodiments, each visual frame in the multiple visual frames is divided using a Gaussian Mixture Model.

In some embodiments, the frame differencing includes computing a difference in luminosity between different frames of the multiple visual frames (e.g., as described with respect to FIG. 3 and/or 504c). In some embodiments, the luminosity is an average or a weighted average of red, green, and blue values of a frame.

In some embodiments, the frame differencing includes computing a difference in intensity between different frames of the multiple visual frames (e.g., as described with respect to FIG. 3 and/or 504c). In some embodiments, intensity is raw brightness of a frame.

In some embodiments, after (and/or in conjunction with) identifying the first motion indication and the second motion indication (and/or in response to identifying the first motion indication or the second motion indication), in accordance with a determination that a third set of one or more criteria is satisfied (e.g., that there is significant motion in an environment and/or that there is significant motion in the one or more visual frames and/or in the one or more audio frames), wherein the third set of one or more criteria includes a criterion that is satisfied when the first motion indication is below a threshold (e.g., that the multiple visual frames are indicative of less motion than the threshold), wherein the third set of one or more criteria includes a criterion that is satisfied based on the second motion indication more than the first motion indication, the computer system outputs (e.g., sends, displays, produces haptic output as, and/or outputs audio as) a second indication that motion has been detected (e.g., result of combination of the first motion indication and the second motion indication as described above with respect to 506 and/or as described above with respect to notifying another computer system in regards to FIGS. 5-6). In some embodiments, the third set of one or more criteria includes a criterion that is satisfied based on a model, such as a machine learning algorithm that is based on the first motion indication and the second motion indication (e.g., weights each indication a different amount in different circumstances). In some embodiments, the first motion indication and/or the second motion indication are identified as part of the determination that the third set of one or more criteria is satisfied. In some embodiments, the third set of one or more criteria is the first set of one or more criteria. In some embodiments, after identifying the first motion indication and the second motion indication, in accordance with a determination that a fourth set of one or more criteria is satisfied (e.g., that there is significant motion in an environment and/or that there is significant motion in the multiple visual frames and/or in the one or more audio frames), wherein the fourth set of one or more criteria includes a criterion that is satisfied when the first motion indication is above the threshold, wherein the fourth set of one or more criteria includes a criterion that is satisfied based on the first motion indication more than the second motion indication, the computer system outputs (e.g., sends, displays, produces haptic output as, and/or outputs audio as) a third indication (e.g. the second indication or another indication different from the second indication) that motion has been detected (e.g., result of combination of the first motion indication and the second motion indication as described above with respect to 506 and/or as described above with respect to notifying another computer system in regards to FIGS. 5-6), wherein the fourth set of one or more criteria is different from the third set of one or more criteria. In some embodiments, the fourth set of one or more criteria includes a criterion that is satisfied based on a model, such as a machine learning algorithm that is based on the first motion indication and the second motion indication (e.g., weights each indication a different amount in different circumstances). In some embodiments, the first motion indication and/or the second motion indication are identified as part of the determination that the fourth set of one or more criteria is satisfied.

In some embodiments, after (and/or in conjunction with) identifying the first motion indication and the second motion indication (and/or in response to identifying the first motion indication or the second motion indication) and in accordance with a determination that a fifth set of one or more criteria is satisfied (e.g., that there is significant motion in an environment and/or that there is significant motion in the multiple visual frames and/or in the one or more audio frames), wherein the fifth set of one or more criteria includes a criterion that is satisfied when the first motion indication is below a threshold (e.g., that the multiple visual frames are indicative of less motion than the threshold), wherein the fifth set of one or more criteria is satisfied based on the second motion indication without being based on the first motion indication, the computer system outputs (e.g., sends, displays, produces haptic output as, and/or outputs audio as) a fourth indication that motion has been detected (e.g., result of combination of the first motion indication and the second motion indication as described above with respect to 506 and/or as described above with respect to notifying another computer system in regards to FIGS. 5-6). In some embodiments, the fifth set of one or more criteria includes a criterion that is satisfied based on a model, such as a machine learning algorithm that is based on the first motion indication and/or the second motion indication (e.g., weights each indication a different amount in different circumstances). In some embodiments, the first motion indication and/or the second motion indication are identified as part of the determination that the fifth set of one or more criteria is satisfied.

In some embodiments, the computer system includes one or more cameras and one or more microphones. In some embodiments, the multiple visual frames are captured via the one or more cameras. In some embodiments, the one or more audio frames are captured via the one or more microphones (e.g., as described with respect to FIG. 5).

In some embodiments, the second motion indication is identified using a model trained on data from one or more sensors not included in the computer system (e.g., as described with respect to FIG. 3).

In some embodiments, the second motion indication is identified using a model trained on data from one or more sensors included in the computer system (e.g., as described with respect to FIG. 3).

In some embodiments, in conjunction with (e.g., together with, before, while, or after) outputting the first indication that motion has been detected, the computer system outputs a set of one or more visual frames (e.g., as described above with respect to notifying another computer system in regards to FIGS. 5-6) (e.g., with or without outputting a set of one or more audio frames). In some embodiments, the multiple visual frames includes the set of one or more visual frames. In some embodiments, the set of one or more visual frames includes the multiple visual frames. In some embodiments, the set of one or more visual frames includes at least one visual frame not included in the multiple visual frames. In some embodiments, the set of one or more visual frames does not includes the multiple visual frames. In some embodiments, the set of one or more visual frames is the multiple visual frames. In some embodiments, the one or more audio frames includes the set of one or more audio frames. In some embodiments, the set of one or more audio frames includes the one or more audio frames. In some embodiments, the set of one or more audio frames includes at least one audio frame not included in the one or more audio frames. In some embodiments, the set of one or more audio frames does not includes the one or more audio frames. In some embodiments, the set of one or more audio frames is the one or more audio frames.

Note that details of the operations described above with respect to process 800 (e.g., FIG. 8) are also applicable in an analogous manner to other processes described herein. For example, process 700 optionally includes one or more of the characteristics of the various processes described above with reference to process 800. For example, the second motion indication of process 800 can be identified using same audio model as the second motion indication of process 700. For brevity, these details are not repeated herein.

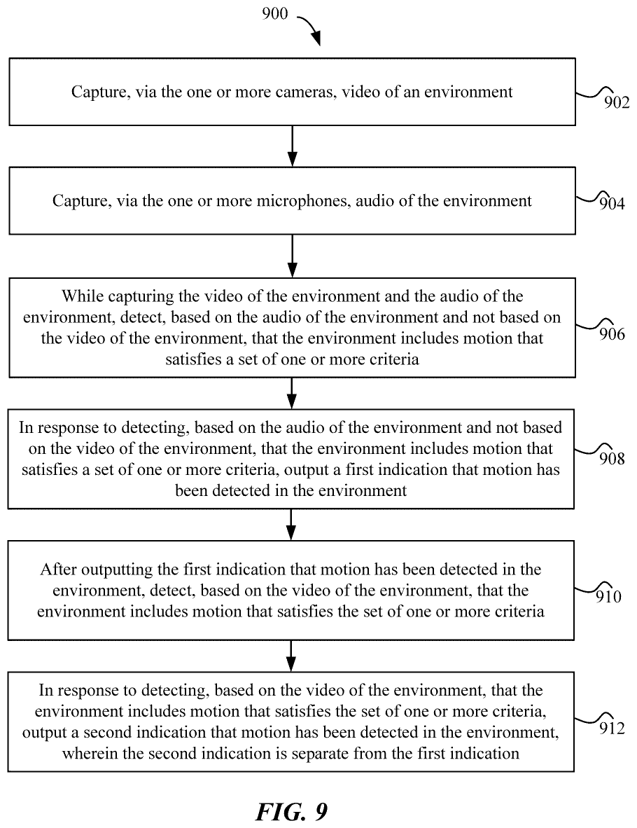

FIG. 9 is a flow diagram illustrating a process (e.g., process 900) for detecting motion using audio before detecting visual motion in accordance with some embodiments. Some operations in process 900 are, optionally, combined, the orders of some operations are, optionally, changed, and some operations are, optionally, omitted.

As described below, process 900 provides an intuitive way for detecting motion using audio before detecting visual motion. Process 900 reduces the cognitive burden on a user, thereby creating a more efficient human-machine interface. For battery-operated computing devices, enabling a user to interact with such devices faster and more efficiently conserves power and increases the time between battery charges.

In some embodiments, process 900 is performed at a computer system (e.g., a device, a watch, a phone, a tablet, a fitness tracking device, a processor, a head-mounted display (HMD) device, a communal device, a media device, a speaker, a television, an electronic device, and/or a personal computing device) that is in communication with (and/or includes) one or more cameras and one or more microphones. In some embodiments, the one or more cameras includes the one or more microphones. In some embodiments, the one or more microphones are separate from the one or more cameras.

The computer system captures (902), via the one or more cameras, video (e.g., 402, 504a, 506a, and/or 602-608) of an environment. In some embodiments, the environment is a physical environment, such as a house, a room, an office, an interior of a car, and/or an outside area.

The computer system captures (904), via the one or more microphones, audio (e.g., 504a and/or 506a) of the environment. In some embodiments, the audio of the environment is captured while capturing the video of the environment. In some embodiments, the video of the environment includes the audio of the environment. In some embodiments, the audio of the environment is separate from the video of the environment.

While capturing (and/or continuing to capture) the video of the environment and the audio of the environment, the computer system detects (906), based on the audio of the environment and not based on the video of the environment, that the environment includes motion that satisfies a set of one or more criteria (e.g., as described with respect to 504d, 506d, and/or the audio motion technique in FIG. 6) (e.g., significant motion and/or motion that has been predefined to cause a notification). In some embodiments, while detecting, based on the audio of the environment and not based on the video of the environment, that the environment includes motion that satisfies the set of one or more criteria, the computer system detects, based on the video of the environment, no motion or motion that does not satisfy the set of one or more criteria (e.g., as described above with respect to 602). In some embodiments, before detecting, based on the audio of the environment and not based on the video of the environment, that the environment includes motion that satisfies the set of one or more criteria, the computer system detects, based on the video of the environment and/or the audio of the environment, no motion or motion that does not satisfy the set of one or more criteria.

In response to detecting, based on the audio of the environment and not based on the video of the environment, that the environment includes motion that satisfies the set of one or more criteria, the computer system outputs (908) (e.g., sends, displays, produces haptic output as, and/or outputs audio as) a first indication that motion has been detected in the environment (e.g., as described with respect to FIGS. 5-6). In some embodiments, in response to detecting, based on the video of the environment and/or the audio of the environment, that the environment does not include motion that satisfies the set of one or more criteria, the computer system forgoes outputting an indication that motion has been detected in the environment. In some embodiments, the first indication includes an indication that motion has been detected in the environment using the audio of the environment (and/or and not using the video of the environment). In some embodiments, the first indication is sent to a personal device of an owner and/or resident associated with the computer system to notify the personal device of motion.

After outputting the first indication that motion has been detected in the environment, the computer system detects (910), based on the video of the environment (and/or (1) based on the audio of the environment or (2) and not based on the audio of the environment), that the environment includes motion that satisfies the set of one or more criteria (e.g., as described with respect to 504c, 506c, and/or the limited compute technique or the higher computer technique in FIG. 6).

In response to detecting, based on the video of the environment, that the environment includes motion that satisfies the set of one or more criteria, the computer system outputs (912) (e.g., sends, displays, produces haptic output as, and/or outputs audio as) a second indication that motion has been detected in the environment, wherein the second indication is separate from the first indication (e.g., as described with respect to FIGS. 5-6). In some embodiments, the second indication is the same as the first indication. In some embodiments, the second indication includes an indication that motion has been detected in the environment using the video of the environment (and/or and using the audio of the environment or and not using the video of the environment). In some embodiments, the second indication is different from the first indication.

In some embodiments, detecting, based on the video of the environment, that the environment includes motion that satisfies the set of one or more criteria is also based on the audio of the environment (e.g., as described with respect to 504d, 506d, and/or FIG. 6).

In some embodiments, detecting, based on the video of the environment, that the environment includes motion that satisfies the set of one or more criteria is not based on the audio of the environment. In some embodiments, after outputting the first indication that motion has been detected in the environment and before detecting, based on the video of the environment, that the environment includes motion that satisfies the set of one or more criteria, the computer system detects, based on the video of the environment and the audio of the environment, that the environment includes motion that satisfies the set of one or more criteria (e.g., as described with respect to 504c, 504d, and/or the limited compute technique or the higher compute technique of FIG. 6). In some embodiments, in response to detecting, based on the video of the environment and the audio of the environment, that the environment includes motion that satisfies the set of one or more criteria, the computer system outputs (e.g., sends, displays, produces haptic output as, and/or outputs audio as) a third indication that motion has been detected in the environment, wherein the third indication is separate from the first indication and the second indication (e.g., as described with respect to FIGS. 5-6). In some embodiments, the third indication is the same as the first indication and/or the second indication. In some embodiments, the third indication includes an indication that motion has been detected in the environment using the video of the environment and the audio of the environment. In some embodiments, the third indication is different from the first indication and/or the second indication.

In some embodiments, detecting, based on the audio of the environment and not based on the video of the environment, that the environment includes motion that satisfies the set of one or more criteria includes identifying a portion of the audio of the environment that is determined to correspond to motion (e.g., as described with respect to 504c, 506c, and/or the audio motion technique of FIG. 6).

In some embodiments, the computer system includes the one or more cameras and the one or more microphones (e.g., as described with respect to 504a, 506a, and/or the audio motion technique of FIG. 6). In some embodiments, the computer system includes an exterior cover. In some embodiments, the one or more cameras and the one or more microphones are within the exterior cover.

In some embodiments, detecting, based on the audio of the environment and not based on the video of the environment, that the environment includes motion that satisfies the set of one or more criteria is performed using a model (e.g., 314) (e.g., a set of one or more heuristics and/or a machine-learning model) trained on audio detected via a set of one or more microphones separate from the one or more microphones (e.g., as described with respect to FIG. 3). In some embodiments, the model is also trained on video detected via a set of one or more cameras separate from the one or more cameras.

In some embodiments, detecting, based on the audio of the environment and not based on the video of the environment, that the environment includes motion that satisfies the set of one or more criteria is performed using a model (e.g., a set of one or more heuristics and/or a machine-learning model) trained on audio detected via the one or more microphones (e.g., as described with respect to FIG. 3). In some embodiments, the model is also trained on video detected via the one or more cameras (e.g., as described with respect to FIG. 3).

In some embodiments, in conjunction with (e.g., as a part of, while, before, or after) outputting the second indication, the computer system outputs (e.g., sends and/or displays) a set of one or more visual frames (e.g., as described with respect to FIGS. 5 and 6 with respect to notifying a controller and/or an owner) (e.g., with or without outputting, such as sending and/or playing, a set of one or more audio frames). In some embodiments, the set of one or more visual frames correspond to motion that has been detected in the environment. In some embodiments, the video includes the set of one or more visual frames. In some embodiments, the set of one or more visual frames are from the video. In some embodiments, the audio includes the set of one or more audio frames. In some embodiments, the set of one or more audio frames are from the audio.

In some embodiments, the set of one or more visual frames are captured after detecting, based on the audio of the environment and not based on the video of the environment, that the environment includes motion that satisfies a set of one or more criteria (e.g., as described with respect to FIGS. 3 and 5).

In some embodiments, in conjunction with (e.g., as a part of, while, before, or after) outputting the first indication, the computer system outputs (e.g., sends and/or plays) a set of one or more audio frames (e.g., as described with respect to FIGS. 5-6) (e.g., with or without outputting, such as sending and/or displaying, a set of one or more visual frames). In some embodiments, the video includes the set of one or more audio frames. In some embodiments, the set of one or more audio frames correspond to motion that has been detected in the environment. In some embodiments, the set of one or more audio frames are from the audio. In some embodiments, the video includes the set of one or more visual frames. In some embodiments, the set of one or more visual frames are from the video. In some embodiments, in conjunction with (e.g., as a part of, while, before, or after) outputting the first indication, the computer system outputs (e.g., sends and/or displays) a set of one or more visual frames (e.g., with or without outputting, such as sending and/or playing, a set of one or more audio frames). In some embodiments, the video includes the set of one or more visual frames. In some embodiments, the set of one or more visual frames are from the video. In some embodiments, the audio includes the set of one or more audio frames. In some embodiments, the set of one or more audio frames are from the audio.

Note that details of the operations described above with respect to process 900 (e.g., FIG. 9) are also applicable in an analogous manner to the processes described herein. For example, process 800 optionally includes one or more of the characteristics of the various processes described herein with reference to process 900. For example, the first motion indication of process 900 can be identified using same audio model as the second motion indication of process 800. For brevity, these details are not repeated herein.

In some embodiments, one or more of processes 300, 400, 500, 700, 800, and 900 (FIGS. 3, 4, 5, 7, 8, and 9) is performed at a first computer system (as described herein) via a system process (e.g., an operating system process and/or a server system process) that is different from one or more applications executing and/or installed on the first computer system.

In some embodiments, one or more of processes 300, 400, 500, 700, 800, and 900 (FIGS. 3, 4, 5, 7, 8, and 9) is performed at a first computer system (as described herein) by an application that is different from a system process.

In some embodiments, the instructions of the application, when executed, control the first computer system to perform one or more of processes 300, 400, 500, 700, 800, and 900 (FIGS. 3, 4, 5, 7, 8, and 9) by calling an application programming interface (API) provided by the system process. In some embodiments, the application performs at least a portion of one or more of processes 300, 400, 500, 700, 800, and 900 (FIGS. 3, 4, 5, 7, 8, and 9) without calling the API.

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, the application is an application that is pre-installed on the first computer system at purchase (e.g., a first party application). In some embodiments, the application is an application that is provided to the first computer system via an operating system update file (e.g., a first party application). In some embodiments, the application is an application that is provided via an application store. In some embodiments, the application store is pre-installed on the first computer system at purchase (e.g., a first party application store) and allows download of one or more applications. In some embodiments, the application store is a third party application store (e.g., an application store that is provided by another device, downloaded via a network, and/or read from a storage device). In some embodiments, the application is a third party application (e.g., an app that is provided by an application store, downloaded via a network, and/or read from a storage device). In some embodiments, the application controls the first computer system to perform one or more of processes 300, 400, 500, 700, 800, and 900 (FIGS. 3, 4, 5, 7, 8, and 9) by calling an application programming interface (API) provided by the system process using one or more parameters.

In some embodiments, at least one API is a software module (e.g., a collection of computer-readable instructions) that provides an interface that allows a different set of instructions (e.g., API calling instructions) to access and use one or more functions, processes, procedures, data structures, classes, and/or other services provided by a set of implementation instructions of the system process. The API can define one or more parameters that are passed between the API calling instructions and the implementation instructions.

As described above, in some embodiments, an application controls a computer system to perform processes 300, 400, 500, 700, 800, and 900 (FIGS. 3, 4, 5, 7, 8, and 9) by calling an application programming interface (API) provided by a system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, API 176 defines a first API call that can be provided by API calling instructions 174, wherein the definition for the first API call specifies call parameters described above with respect to processes 300, 400, 500, 700, 800, and 900 (FIGS. 3, 4, 5, 7, 8, and 9).

In some embodiments, API 176 defines a first API call response that can be provided to an application by API calling instructions 174, wherein the first API call response includes parameters described above with respect to processes 300, 400, 500, 700, 800, and 900 (FIGS. 3, 4, 5, 7, 8, and 9).

In some embodiments, the set of implementation instructions is a system software module (e.g., a collection of computer-readable instructions) that is constructed to perform an operation in response to receiving an API call via the API. In some embodiments, the set of implementation instructions is constructed to provide an API response (via the API) as a result of processing an API call.

In some embodiments, the set of implementation instructions is included in the device (e.g., 168) that runs the application. In some embodiments, the set of implementation instructions is included in an electronic device that is separate from the device that runs the application.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the techniques and their practical applications. Others skilled in the art are thereby enabled to best utilize the techniques and various examples with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

In some embodiments, content is automatically generated by one or more computer systems in response to a request to generate the content. The automatically-generated content is optionally generated on-device (e.g., generated at least in part by a computer system at which a request to generate the content is received) and/or generated off-device (e.g., generated at least in part by one or more nearby computers that are available via a local network or one or more computers that are available via the internet). This automatically-generated content optionally includes visual content (e.g., images, graphics, and/or video), audio content, and/or text content.

In some embodiments, novel automatically-generated content that is generated via one or more artificial intelligence (AI) processes is referred to as generative content (e.g., generative images, generative graphics, generative video, generative audio, and/or generative text). Generative content is typically generated by an AI process based on a prompt that is provided to the AI process. An AI process typically uses one or more AI models to generate an output based on an input. An AI process optionally includes one or more pre-processing steps to adjust the input before it is used by the AI model to generate an output (e.g., adjustment to a user-provided prompt, creation of a system-generated prompt, and/or AI model selection). An AI process optionally includes one or more post-processing steps to adjust the output by the AI model (e.g., passing AI model output to a different AI model, upscaling, downscaling, cropping, formatting, and/or adding or removing metadata) before the output of the AI model used for other purposes such as being provided to a different software process for further processing or being presented (e.g., visually or audibly) to a user. An AI process that generates generative content is sometimes referred to as a generative AI process.

A prompt for generating generative content can include one or more of: one or more words (e.g., a natural language prompt that is written or spoken), one or more images, one or more drawings, and/or one or more videos. AI processes can include machine learning models including neural networks. Neural networks can include transformer-based deep neural networks such as large language models (LLMs). Generative pre-trained transformer models are a type of LLM that can be effective at generating novel generative content based on a prompt. Some AI processes use a prompt that includes text to generate either different generative text, generative audio content, and/or generative visual content. Some AI processes use a prompt that includes visual content and/or an audio content to generate generative text (e.g., a transcription of audio and/or a description of the visual content). Some multi-modal AI processes use a prompt that includes multiple types of content (e.g., text, images, audio, video, and/or other sensor data) to generate generative content. A prompt sometimes also includes values for one or more parameters indicating an importance of various parts of the prompt. Some prompts include a structured set of instructions that can be understood by an AI process that include phrasing, a specified style, relevant context (e.g., starting point content and/or one or more examples), and/or a role for the AI process.

Generative content is generally based on the prompt but is not deterministically selected from pre-generated content and is, instead, generated using the prompt as a starting point. In some embodiments, pre-existing content (e.g., audio, text, and/or visual content) is used as part of the prompt for creating generative content (e.g., the pre-existing content is used as a starting point for creating the generative content). For example, a prompt could request that a block of text be summarized or rewritten in a different tone, and the output would be generative text that is summarized or written in the different tone. Similarly, a prompt could request that visual content be modified to include or exclude content specified by a prompt (e.g., removing an identified feature in the visual content, adding a feature to the visual content that is described in a prompt, changing a visual style of the visual content, and/or creating additional visual elements outside of a spatial or temporal boundary of the visual content that are based on the visual content). In some embodiments, a random or pseudo-random seed is used as part of the prompt for creating generative content (e.g., the random or pseud-random seed content is used as a starting point for creating the generative content). For example, when generating an image from a diffusion model, a random noise pattern is iteratively denoised based on the prompt to generate an image that is based on the prompt. While specific types of AI processes have been described herein, it should be understood that a variety of different AI processes could be used to generate generative content based on a prompt.

Some embodiments described herein can include use of artificial intelligence and/or machine learning systems (sometimes referred to herein as the AI/ML systems). The use can include collecting, processing, labeling, organizing, analyzing, recommending and/or generating data. Entities that collect, share, and/or otherwise utilize user data should provide transparency and/or obtain user consent when collecting such data. The present disclosure recognizes that the use of the data in the AI/ML systems can be used to benefit users. For example, the data can be used to train models that can be deployed to improve performance, accuracy, and/or functionality of applications and/or services. Accordingly, the use of the data enables the AI/ML systems to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the AI/ML systems are also contemplated by the present disclosure.

The present disclosure contemplates that, in some embodiments, data used by AI/ML systems includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML systems, should attempt to comply with well-established privacy policies and/or privacy practices.

For example, such entities may implement and consistently follow policies and practices recognized as meeting or exceeding industry standards and regulatory requirements for developing and/or training AI/ML systems. In doing so, attempts should be made to ensure all intellectual property rights and privacy considerations are maintained. Training should include practices safeguarding training data, such as personal information, through sufficient protections against misuse or exploitation. Such policies and practices should cover all stages of the AI/ML systems development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, AI/ML systems may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other embodiments, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some embodiments, data from multiple devices can be combined in a privacy-preserving manner to train an ML model.

In some embodiments, the present disclosure contemplates that data used for AI/ML systems may be kept strictly separated from platforms where the AI/ML systems are deployed and/or used to interact with users and/or process data. In such embodiments, data used for offline training of the AI/ML systems may be maintained in secured datastores with restricted access and/or not be retained beyond the duration necessary for training purposes. In some embodiments, the AI/ML systems may utilize a local memory cache to store data temporarily during a user session. The local memory cache may be used to improve performance of the AI/ML systems. However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during training and/or use of the AI/ML systems. The AI/ML systems should be monitored for changes in underlying data distribution such as concept drift or data skew that can degrade performance of the AI/ML systems over time.

In some embodiments, the AI/ML systems are trained using a combination of offline and online training. Offline training can use curated datasets to establish baseline model performance, while online training can allow the AI/ML systems to continually adapt and/or improve. The present disclosure recognizes the importance of maintaining strict data governance practices throughout this process to ensure user privacy is protected.

In some embodiments, the AI/ML systems may be designed with safeguards to maintain adherence to originally intended purposes, even as the AI/ML systems adapt based on new data. Any significant changes in data collection and/or applications of an AI/ML system use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the AI/ML systems and/or for use as input during the inference stage of such systems. In yet another example, the present technology should be configured to allow users to be able to select to limit the length of time data is maintained or entirely prohibit the use of their data for use by the AI/ML systems. In addition to providing “opt in” and “opt out” options, the present disclosure contemplates providing notifications relating to the access or use of personal information. For instance, a user can be notified when their data is being input into the AI/ML systems for training or inference purposes, and/or reminded when the AI/ML systems generate outputs or make decisions based on their data.

The present disclosure recognizes AI/ML systems should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to third-party products and/or services in the outputs should not be construed as endorsements or affiliations by the entities providing the AI/ML systems. Generated content can be filtered for potentially inappropriate or dangerous material prior to being presented to users, while human oversight and/or ability to override or correct erroneous or undesirable outputs can be maintained as a failsafe.

The present disclosure further contemplates that users of the AI/ML systems should refrain from using the services in any manner that infringes upon, misappropriates, or violates the rights of any party. Furthermore, the AI/ML systems should not be used for any unlawful or illegal activity, nor to develop any application or use case that would commit or facilitate the commission of a crime, or other tortious, unlawful, or illegal act. The AI/ML systems should not violate, misappropriate, or infringe any copyrights, trademarks, rights of privacy and publicity, trade secrets, patents, or other proprietary or legal rights of any party, and appropriately attribute content as required. Further, the AI/ML systems should not interfere with any security, digital signing, digital rights management, content protection, verification, or authentication mechanisms. The AI/ML systems should not misrepresent machine-generated outputs as being human-generated.

As described above, one aspect of the present technology is the gathering and use of data available from various sources to improve motion detection. The present disclosure contemplates that in some instances, this gathered data can include personal information data that uniquely identifies or can be used to detect or locate a specific person. Such personal information data can include demographic data, location-based data, biometric data, audio-visual data, home automation systems data, email addresses, home addresses, or any other identifying information.

The present disclosure recognizes that the use of such personal information data, in the present technology, can be used to the benefit of users. For example, the personal information data can be used to improve motion detection. Accordingly, use of such personal information data enables better motion detection. Further, other uses for personal information data that benefit the user are also contemplated by the present disclosure.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of image capture, the present technology can be configured to allow users to select to “opt in” or “opt out” of participation in the collection of personal information data during registration for services.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, motion can be detected by inferring motion based on non-personal information data or a bare minimum amount of personal information, such as using pre-trained visual and/or audio based motion detection models on anonymized datasets of motion events or other non-personal information.

What is claimed is:

1. A method, comprising:
at a computer system that is in communication with one or more cameras and one or more microphones:
capturing, via the one or more cameras, video of an environment;
capturing, via the one or more microphones, audio of the environment;
while capturing the video of the environment and the audio of the environment, detecting, based on the audio of the environment and not based on the video of the environment, that the environment includes motion that satisfies a set of one or more criteria;
in response to detecting, based on the audio of the environment and not based on the video of the environment, that the environment includes motion that satisfies the set of one or more criteria, outputting a first indication that motion has been detected in the environment;
after outputting the first indication that motion has been detected in the environment, detecting, based on the video of the environment, that the environment includes motion that satisfies the set of one or more criteria; and
in response to detecting, based on the video of the environment, that the environment includes motion that satisfies the set of one or more criteria, outputting a second indication that motion has been detected in the environment, wherein the second indication is separate from the first indication.

2. The method of claim 1, wherein detecting, based on the video of the environment, that the environment includes motion that satisfies the set of one or more criteria is also based on the audio of the environment.

3. The method of claim 1, wherein detecting, based on the video of the environment, that the environment includes motion that satisfies the set of one or more criteria is not based on the audio of the environment, the method further comprising:
after outputting the first indication that motion has been detected in the environment and before detecting, based on the video of the environment, that the environment includes motion that satisfies the set of one or more criteria, detecting, based on the video of the environment and the audio of the environment, that the environment includes motion that satisfies the set of one or more criteria; and
in response to detecting, based on the video of the environment and the audio of the environment, that the environment includes motion that satisfies the set of one or more criteria, outputting a third indication that motion has been detected in the environment, wherein the third indication is separate from the first indication and the second indication.

4. The method of claim 1, wherein detecting, based on the audio of the environment and not based on the video of the environment, that the environment includes motion that satisfies the set of one or more criteria includes identifying a portion of the audio of the environment that is determined to correspond to motion.

5. The method of claim 1, wherein the computer system includes the one or more cameras and the one or more microphones.

6. The method of claim 1, wherein detecting, based on the audio of the environment and not based on the video of the environment, that the environment includes motion that satisfies the set of one or more criteria is performed using a model trained on audio detected via a set of one or more microphones separate from the one or more microphones.

7. The method of claim 1, wherein detecting, based on the audio of the environment and not based on the video of the environment, that the environment includes motion that satisfies the set of one or more criteria is performed using a model trained on audio detected via the one or more microphones.

8. The method of claim 1, further comprising:
in conjunction with outputting the second indication, outputting a set of one or more visual frames.

9. The method of claim 8, wherein the set of one or more visual frames are captured after detecting, based on the audio of the environment and not based on the video of the environment, that the environment includes motion that satisfies a set of one or more criteria.

10. The method of claim 1, further comprising:
in conjunction with outputting the first indication, outputting a set of one or more audio frames.

11. A non-transitory computer-readable storage medium storing one or more programs configured to be executed by one or more processors of a computer system that is in communication with one or more cameras and one or more microphones, the one or more programs including instructions for:
capturing, via the one or more cameras, video of an environment;
capturing, via the one or more microphones, audio of the environment;
while capturing the video of the environment and the audio of the environment, detecting, based on the audio of the environment and not based on the video of the environment, that the environment includes motion that satisfies a set of one or more criteria;
in response to detecting, based on the audio of the environment and not based on the video of the environment, that the environment includes motion that satisfies the set of one or more criteria, outputting a first indication that motion has been detected in the environment;
after outputting the first indication that motion has been detected in the environment, detecting, based on the video of the environment, that the environment includes motion that satisfies the set of one or more criteria; and
in response to detecting, based on the video of the environment, that the environment includes motion that satisfies the set of one or more criteria, outputting a second indication that motion has been detected in the environment, wherein the second indication is separate from the first indication.

12. A computer system configured to communicate with one or more cameras and one or more microphones, the computer system comprising:
one or more processors; and
memory storing one or more programs configured to be executed by the one or more processors, the one or more programs including instructions for:
capturing, via the one or more cameras, video of an environment;
capturing, via the one or more microphones, audio of the environment;
while capturing the video of the environment and the audio of the environment, detecting, based on the audio of the environment and not based on the video of the environment, that the environment includes motion that satisfies a set of one or more criteria;
in response to detecting, based on the audio of the environment and not based on the video of the environment, that the environment includes motion that satisfies the set of one or more criteria, outputting a first indication that motion has been detected in the environment;
after outputting the first indication that motion has been detected in the environment, detecting, based on the video of the environment, that the environment includes motion that satisfies the set of one or more criteria; and
in response to detecting, based on the video of the environment, that the environment includes motion that satisfies the set of one or more criteria, outputting a second indication that motion has been detected in the environment, wherein the second indication is separate from the first indication.
